(19) United States
(12) Patent Application Publication
(10) Pub. No.: US 2026/0253030 A1
(43) Pub. Date: Aug. 27, 2026

(54) DETERMINING PICK PALLET BUILD OPERATIONS AND PICK SEQUENCING

(71) Applicant: Lineage Logistics, LLC, Irvine, CA (US)

(72) Inventors: Thomas Eugene Murphy, San Francisco, CA (US); Daniel Thomas Wintz, San Francisco, CA (US); René van Eekelen, Bergen op Zoom (NL); Elias MacGregor Mills, Brookhaven, GA (US)

(21) Appl. No.: 19/649,498

(22) Filed: Apr. 16, 2026

Related U.S. Application Data
(63) Continuation-in-part of application No. 18/455,387, filed on Aug. 24, 2023, now Pat. No. 12,632,828.
Application No. 18/455,387 is a continuation of application No. 17/330,328, filed on May 25, 2021, now Pat. No. 11,755,994.

(51) Int. Cl. G06Q 10/0875; G06Q 10/0631

(52) U.S. Cl. CPC G06Q 10/0875; G06Q 10/06316

(57) ABSTRACT

Methods and systems for determining a pallet build sequence can include receiving a set of pick order requests including multiple lists of items to be packed onto multiple pallets. Candidate pick items and their facility locations are identified. Full layers for at least one candidate item are identified to form a base layer for one or more pallets. Cases for the pick order requests are identified. An order for picking the cases to be packed directly or indirectly on top of the base layers is determined based on structural information for the cases. Build instructions for the pallets are determined based on item data for each case. The build instructions are transmitted to a computing device to route a facility worker or an automated layer picker to pick the cases according to the instructions.

### CROSS-REFERENCE TO RELATED APPLICATIONS

This application is a continuation-in-part of U.S. application Ser. No. 18/455,387, filed Aug. 24, 2023, which is a continuation of U.S. application Ser. No. 17/330,328, filed May 25, 2021 and issued on Sep. 12, 2023 as U.S. Pat. No. 11,755,994, the entire contents of each of which are incorporated herein by reference in their entirety.

### TECHNICAL FIELD

This document describes devices, systems, and methods related to pallet build sequencing determinations.

### BACKGROUND

A warehouse or other storage facility can be used to store items. Items can be stored for different periods of time and under different storage conditions, which can be based on a vendor, customer, or other relevant user. Items can be stored until they are requested by a relevant user. A customer can, for example, request certain items to be picked and shipped to the customer within a predetermined timeframe. The customer can request items of a same type and/or items of different types. When the customer requests items in a pick order request, the customer can also indicate quantities of each item that are being requested.

When the pick order request is received at the warehouse, warehouse workers can work to fulfill that request. The warehouse workers can determine an order to pick the requested items. Sometimes, the pick order can be random. Sometimes, the pick order can be based on locations of the items relative to each other in the warehouse. When the warehouse workers pick the items, they often times may travel around to different storage rooms and/or aisles in the warehouse to get all the items in the pick order request. This travel can require significant amounts of labor, energy, and time, especially if the warehouse worker is moving a heavy pick pallet around the warehouse to collect all the items in the request. It can take a long time to fulfill the pick order request. Moreover, the pick pallet can contain all the requested items, but some of the items can be damaged or crushed based on an order that the items are picked and stacked on the pick pallet. The warehouse worker may not be aware of how much weight certain items can support, especially if the warehouse worker is rushing to complete the pick order request in time, and therefore the worker can stack heavy items on top of items that may not be able to support such weight. The resulting pick pallet may not be structurally sound. Moreover, the customer can receive damaged items, which can cause dissatisfaction with the warehouse.

### SUMMARY

The document relates to determining efficient pick pallet build operations in a warehouse environment that can balance a variety of competing objectives, such as labor efficiency in building pick pallets, the pallet's structural integrity, and avoiding the possibility of building pallets that may result in items being damaged (i.e., items at bottom of pallet being crushed by heavy items on top level of pallet). The disclosed technology can also provide for splitting pick orders into individual pallets and determining pick sequences for items on a pallet in a manner that optimizes labor efficiency and that results in structurally sound pick pallets. Pick pallets can be structurally sound when items are stacked on top of each other without causing items in lower layers to be crushed or otherwise damaged.

A forklift or warehouse worker can move from a back of a warehouse to a front of the warehouse. As the forklift moves from back to front, the forklift can pick up items or layers of items and place them on a pallet to build a pick pallet that fulfills a pick order request. Thus, a first item or layer of items that is picked for a base of the pallet can be located at the back of the warehouse and a top item or layer of items that is picked can be located at the front of the warehouse. The disclosed technology can provide for determining an optimal pick sequence by analyzing items or layers of items in reverse, from the front of the warehouse to the back of the warehouse. As a result, the disclosed technology can provide for determining whether layers of items are able to support weight of layers that are added on top. If the layers can support the added weight, then the layers are less likely to be crushed or otherwise damaged. Thus, a more structurally sound pallet can be built.

Input can include a quantity of items (e.g., cases) of each product that a requesting user needs in their pick order request. A goal of the disclosed technology can be to receive this input and determine how many pallets need to be made to satisfy the request, how to groups the pallet builds in a way that is most efficient for a warehouse worker, and how to build pallets that are structurally sound. As a result, more labor and energy efficient pallets can be built to satisfy pick order requests. One or more pallets can be built per aisle, thereby reducing an amount of distance, time, and energy needed to build the pallets. A first item in the aisle can be selected, and added to a bottom of the pallet. The disclosed technology can then provide for trying to add a next item in the aisle on top of the bottom layer and determining whether the added item would crush the bottom item. If the added item would not crush the bottom item, then the added item can remain in the pallet build sequence and a next item in the aisle can be selected to perform the same analysis. If the added item would crush the bottom item, then a next item in the aisle can be selected to determine whether this item would crush the bottom item. This can be an iterative decision-making process used to determine an optimal yet efficient pallet build sequence. Any pallets built per aisle that are not full can then be combined into single pallet builds.

The disclosed technology can apply to both manual and automated warehouses. Optimal pick sequencing can be determined in order to efficiently use labor in the warehouse environment and build solid pick pallets that may not break or fall apart. The disclosed technology can be used to determine how to construct a pallet and where to pick items from in order to construct such pallet. Ordering of items to pick can also be optimized. Full layers can be picked first and used as base or bottom layers on the pallet. This can be a scoop and go opportunity. Other items in a pick request that are physically closest to the picked full layer(s) can be considered next in determining how to build the pallet. The items in the pick request can be analyzed for whether they have the ability to support a layer that is placed on top while also satisfying height requirements for the pallet.

Although the disclosed inventive concepts include those defined in the attached claims, it should be understood that the inventive concepts can also be defined in accordance with the following embodiments.
Embodiment 1 is a method for dynamically optimizing pallet build sequences across a facility, the method including: receiving, by a computing system, a collection of pick order requests including a collection of lists of items to be packed onto a collection of pallets; identifying, by the computing system, candidate pick items in the facility that can be used to fulfill the collection of pick order requests; identifying, by the computing system, locations of the candidate pick items in the facility; identifying, by the computing system, one or more full layers of at least one of the candidate pick items, wherein at least one of the full layers includes a base layer for one or more of the collection of pallets; identifying, by the computing system, cases of the candidate pick items to be picked to fulfill the collection of pick order requests; determining, by the computing system and based on structural information for the identified cases of the candidate pick items, an order for picking the cases of the candidate pick items to be packed on top of the one or more full layers that include the base layer for one or more pallets of the collection of pallets; determining, by the computing system, build instructions for the one or more pallets of the collection of pallets based on item data corresponding to each of the identified cases; and transmitting, by the computing system to a computing device, the build instructions that, when executed, cause the computing device to route a facility worker or an automated layer picker to pick the cases according to the build instructions.
Embodiment 2 is the method of embodiment 1, wherein the collection of pick order requests is based on a collection of outbound transport vehicles.
Embodiment 3 is the method of embodiment 2, wherein the collection of outbound transport vehicles includes one or more outbound transport vehicles docked at one or more loading doors, and one or more other outbound transport vehicles scheduled to dock at one or more loading doors within a predetermined period of time.
Embodiment 4 is the method of embodiment 1, further including: identifying, by the computing system, a first facility state, wherein the build instructions are further based on the first facility state; identifying, by the computing system, an updated facility state; determining, by the computing system, updated build instructions for the one or more pallets of the collection of pallets based on updated item data corresponding to each of the identified cases, wherein the updated build instructions indicate placement of each of the identified cases directly or indirectly on top of the base layer; and transmitting, by the computing system to a computing device, the updated build instructions that, when executed, cause the computing device to route the facility worker or the automated layer picker to pick the cases according to the updated build instructions.
Embodiment 5 is the method of embodiment 4, wherein the updated facility state includes a reported pallet build execution failure, and wherein the computing system automatically resolves the reported pallet build execution failure by canceling at least a portion of the build instructions and creating the updated build instructions without requiring manual inventory control intervention.
Embodiment 6 is the method of embodiment 1, wherein the locations of the candidate pick items distinguish between ground-level pick zone locations and elevated storage locations in the facility.
Embodiment 7 is the method of embodiment 6, further including: executing, by the computing system, an arrangement model configured to generate the build instructions, wherein generating the build instructions includes interdependently determining: a sequence of replenishment tasks for moving source pallets from the elevated storage locations into the ground-level pick zone locations; and a sequence of outbound pick tasks to fulfill the collection to pick order requests, the outbound pick tasks including partial picks from the ground-level pick zone locations and cherry picks from the elevated storage locations.
Embodiment 8 is the method of embodiment 7, wherein executing the arrangement model includes processing a mixed integer program for a predetermined maximum amount of time, and returning a best-found solution for the build instructions upon expiration of the predetermined maximum amount of time.
Embodiment 9 is the method of embodiment 7, further including: storing, by the computing system, the build instructions in an unreleased state; re-evaluating, by the computing system at a configured time interval, the build instructions in the unreleased state against an updated facility state; and in response to determining that a modified sequence of outbound pick tasks and replenishment tasks yields a higher efficiency score for the updated facility state, canceling at least one of the build instructions in the unreleased state and creating a new build instruction to fulfill a corresponding one of the build instructions.
Embodiment 10 is the method of embodiment 9, further including: assigning a first portion of the build instructions to the facility worker or the automated layer picker for execution; transitioning the first portion of the build instructions from the unreleased state to a locked state in response to the assigning; and excluding the first portion of the build instructions in the locked state from being canceled during the re-evaluating by the computing system.
Embodiment 11 is the method of embodiment 9, wherein determining the modified sequence of outbound pick tasks further includes: identifying one or more other full layers of at least one of the candidate pick items to include the base layer for one or more of the collection of pallets; and iteratively determining another order for picking the cases of the candidate pick items to be packed on top of the one or more full layers that include the base layer.
Embodiment 12 is the method of embodiment 1, wherein the structural information includes a maximum weight load that each case can support without being crushed.
Embodiment 13 is the method of embodiment 12, wherein the maximum weight load for each of the identified cases is determined in a process including: determining a load on a layer of a source pallet having at least one of the identified cases, wherein the load is a weight for a layer multiplied by one less than a number of layers on the source pallet; and determining the maximum weight load based on applying a margin threshold to the load.
Embodiment 14 is a facility including: a collection of storage locations in the facility configured to store a collection of items; at least one facility vehicle configured to travel to the collection of storage locations to pick items used for fulfilling customer orders; and a computer system configured to (i) determine pallet build sequences in the facility using the collection of items stored in the collection of storage locations and (ii) control the at least one facility vehicle to automatically perform the pallet build sequences, wherein the computer system performs operations including: receiving a collection of pick order requests including a collection of lists of items to be packed onto a collection of pallets; identifying candidate pick items in the facility that can be used to fulfill the collection of pick order requests; identifying locations of the candidate pick items in the facility; identifying one or more full layers of at least one of the candidate pick items, wherein at least one of the full layers includes one or more base layers for one or more of the collection of pallets; identifying cases of the candidate pick items to be picked to fulfill the collection of pick order requests; determining, based on structural information for the identified cases of the candidate pick items, an order for picking the cases of the candidate pick items to be packed on top of the one or more full layers that include one or more base layers for one or more pallets of the collection of pallets; determining build instructions for the one or more pallets of the collection of pallets based on item data corresponding to each of the identified cases; and transmitting to a computing device the build instructions that, when executed, cause the computing device to route a facility worker or the at least one facility vehicle to pick the cases according to the build instructions.
Embodiment 15 is the facility of embodiment 14, wherein the structural information includes a maximum weight load that each case can support without being crushed, wherein the maximum weight load for each of the identified cases is determined in a process including: determining a load on a layer of a source pallet having at least one of the identified cases, wherein the load is a weight for a layer multiplied by one less than a number of layers on the source pallet; and determining the maximum weight load based on applying a margin threshold to the load.
Embodiment 16 is the facility of embodiment 14, wherein determining the order for picking the identified cases includes: selecting a next nearest case of the candidate pick items to a storage location of at least one of the full layers; determining whether a storage location of the next nearest case is within a threshold distance from the storage location of the at least one of the full layers; and selecting the next nearest case to be picked for packing on top of the one or more base layers based on determining that the storage location of the next nearest case is within the threshold distance.
Embodiment 17 is the facility of embodiment 16, wherein determining the order for picking the identified cases includes: selecting a case of the candidate pick items; determining whether the selected case can support a minimum threshold weight positioned on top of the selected case without being crushed; and identifying the selected case to be picked for packing on top of the one or more base layers based on a determination that the selected case can support the minimum threshold weight without being crushed.
Embodiment 18 is the facility of embodiment 14, wherein the collection of pick order requests is based on a collection of outbound transport vehicles.
Embodiment 19 is the facility of embodiment 18, wherein the collection of outbound transport vehicles includes one or more outbound transport vehicles docked at one or more loading doors, and one or more other outbound transport vehicles scheduled to dock at one or more loading doors within a predetermined period of time.
Embodiment 20 is the facility of embodiment 14, further including: identifying, by the computing system, a first facility state, wherein the build instructions are further based on the first facility state; identifying, by the computing system, an updated facility state; determining, by the computing system, updated build instructions for the one or more pallets of the collection of pallets based on updated item data corresponding to each of the identified cases, wherein the updated build instructions indicate placement of each of the identified cases directly or indirectly on top of the one or more base layers; and transmitting, by the computing system to a computing device, the updated build instructions that, when executed, cause the computing device to route the facility worker or the at least one facility vehicle to pick the cases according to the updated build instructions.
Embodiment 21 is a method for dynamically optimizing pallet build sequences across a facility, the method including: receiving, by a computing system, a collection of pick order requests including a collection of lists of items to be packed onto a collection of pallets for one or more of a first outbound transport vehicle docked at a first loading door of the facility and a second outbound transport vehicle scheduled to dock at a second loading door of the facility within a predetermined period of time; identifying, by the computing system, a first facility state; identifying, by the computing system, candidate pick items in the facility that can be used to fulfill the collection of pick order requests based on the first facility state; identifying, by the computing system, locations of the candidate pick items in the facility based on the first facility state; identifying, by the computing system, cases of the candidate pick items to be picked to fulfill the collection of pick order requests; determining, by the computing system and based on structural information for the identified cases of the candidate pick items, an order for picking the cases of the candidate pick items to be packed on top of one or more full layers that include a base layer for one or more pallets of the collection of pallets; determining, by the computing system, build instructions for the one or more pallets of the collection of pallets based on item data corresponding to each of the identified cases; transmitting, by the computing system to a computing device, the build instructions that, when executed, cause the computing device to route a facility worker or an automated layer picker to pick the cases according to the build instructions; identifying, by the computing system, an updated facility state; determining, by the computing system, updated build instructions for the one or more pallets of the collection of pallets based on updated item data corresponding to each of the identified cases, wherein the updated build instructions indicate placement of each of the identified cases directly or indirectly on top of the base layer; and transmitting, by the computing system to a computing device, the updated build instructions that, when executed, cause the computing device to route the facility worker or the automated layer picker to pick the cases according to the updated build instructions.

The devices, system, and techniques described herein may provide one or more of the following advantages. For example, the disclosed technology can provide for building pick pallets in such a way that is labor and energy efficient. A collection of pallets can be built from the back of the warehouse to the front of the warehouse. Items to build the pallets can be picked in a sequence that may not require the forklift or warehouse worker to backtrack or navigate different aisles, thereby reducing an amount of time, labor, space, equipment wear, and energy needed to build the pallets. Moreover, this can be advantageous to reduce an amount of time that warehouse workers may need to spend inside cold storage area of the warehouse. The disclosed techniques can provide for consolidating orders into fewer pallet builds. As a result, the warehouse workers may enter the cold storage areas once to complete multiple orders rather than multiple times to complete each of the orders. The pallets can also be built faster while using less energy. Instead, a pallet can be built with items that are located within one aisle. Moreover, since the pallet can be built from the back of the warehouse to the front of the warehouse, building can be more timely and/or energy efficient. This is because the forklift may not be required to transport a heavy pallet over a long distance and/or back and forth through one or more different aisles. A pallet that is initially built at the back of the warehouse can increase in weight as more items closer to the front of the warehouse are added to the pallet. By the time the pallet reaches the front of the warehouse, the pallet can be at a maximum weight load. Thus, although heavy, the pallet does not need to be moved a great distance to a docking area or other destination location that is at the front of the warehouse. Less energy and labor is used to move the built pallet to the destination location.

As another example, the disclosed technology can provide for building structurally sound pallets. The disclosed technology provides for analyzing pallet build sequencing from the front to the back of the warehouse. In other words, analysis is performed in reverse of a direction that the items would actually be picked in real-time to build the pallet. Strength and crushability can be determined for each potential layer that can be built on the pallet. For example, the disclosed technology can provide for starting with a top layer (e.g., items at the front of the warehouse, which would be last to be picked in real-time), adding a layer of items beneath it (e.g., items next from the front of the warehouse), and determining whether the layer beneath would be able to support the top layer without being crushed. When strength and crushability can be assessed for each potential layer, a more structurally sound and strong pallet can be built. The disclosed technology can provide for selecting an aisle that contains items from a pick order request. For that aisle, first items closest to the front of the warehouse can be selected first. Second items can then be selected and added beneath the first items in order to determine whether the second items are able to support weight of the first items without being crushed. Iterative decision-making can be performed to determine whether whatever weight may be borne on top of a bottom layer of the pallet is how much weight the bottom layer can support without being crushed. If the item that would go on the bottom layer cannot support the weight, then another item in the aisle can be selected to determine whether it can be borne by the bottom layer.

The disclosed technology can also be computationally efficient, thereby allowing for more pallet build sequencing decisions to be made in real-time. For example, if there are 10 different items on a pick order, there are 10 factorial (10!=3,628,800) different possible pick and build sequences for a single pallet. Attempting to evaluate each of these pick sequences against each other, including simulation and evaluation of whether they will be structurally sound, efficient, and will avoid crushing items in the pick order, creates a significant computational burden. And this burden is only increased as the number of items on the pick order increases, and as varied groupings of items on different pallets are also considered. Accordingly, the disclosed innovation provides a that is capable of arriving at a good solution that can balances multiple competing factors (i.e., minimize travel and pick time, avoid crushing items, build pallet that is structurally sound and unlikely to tip/lean) in a manner that is computationally efficient and that minimizes the use of computational resources to arrive at the solution. For example, the disclosed innovation can arrive at a solution by considering only a small subset of all possible combinations, and can do so without necessarily comparing solutions against each other. The disclosed technology can permit for pick solutions to be generated in real time and in a highly responsive manner, which can be beneficial in a warehousing system that is handling large volumes of similar requests and that needs to be able to provide responses with low latency to avoid backups within the warehouse.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a conceptual diagram of a system for determining a pick pallet build operation in a warehouse environment.

FIG. 2 is a block diagram for determining what pallets to build per aisle in order to fulfill a pick order request.

FIG. 3A is a flowchart of a process for determining a pick sequence for an aisle pallet.

FIG. 3B is a block diagram for determining the pick sequence of FIG. 3A.

FIGS. 4A-D is a flowchart of a process for determining an optimal pallet build using the techniques described herein.

FIGS. 5A-B is a flowchart of a process for determining an optimal pallet build using scoop and go, full, and partial layers.

FIG. 5C is a block diagram for determining the optimal pallet build of FIGS. 5A-B.

FIG. 6 is a flowchart of a process for determining a maximum amount of weight that a layer can support.

FIG. 7 is a system diagram of one or more components used to perform the techniques described herein.

FIG. 8A is a conceptual diagram of another system for determining a pick pallet build operation in a warehouse facility environment.

FIG. 8B is a conceptual side view diagram of the warehouse facility environment of FIG. 8A.

FIG. 9 is a flowchart of a process for determining a pick sequence for an aisle pallet.

FIG. 10 is a flowchart of a process for determining and responding to facility state changes.

FIG. 11 is a flowchart of a process for determining a pick zone replenishment.

FIG. 12 is a flowchart of a process for determining a partial updated pick sequence for an aisle pallet.

FIG. 13 is a flowchart of another process for determining a pick sequence for an aisle pallet.

FIG. 14 is a schematic diagram that shows an example of a computing device and a mobile computing device that can be used to perform the techniques described herein.

Like reference symbols in the various drawings indicate like elements.

### DETAILED DESCRIPTION OF ILLUSTRATIVE EMBODIMENTS

This document relates to determining optimal and efficient pick pallet build operations in a warehouse environment. The disclosed technology can provide for building pick pallets on an aisle basis. Less-than-full pallets generated per aisle can then be combined into mixed pallets. The disclosed technology can also provide for minimizing damage or crushing of items that are layered in the pick pallets. Moreover, the disclosed technology can minimize labor required to pick items to build the pallets while also minimizing pick-path lengths.

The disclosed technology can be applied to both manual and automated warehouses. In a manual warehouse, a call to determine a pick pallet build operation can be made at a point that a pick order request is received. This call can populate placeholder tasks in a task queue to allow for labor scheduling and other planning purposes needed to fulfill the pick order request in a timely fashion. Additional calls can be made before a first pick task is performed in order to determine the pick pallet build operation based on latest conditions in the warehouse. The manual pick operation call can return, for each pick pallet to build, (1) a set of SKUs on the pick pallet, (2) for each SKU on the pick pallet, a set of locations that can satisfy the pick (which can also satisfy a first-in-first-out order), (3) an order that items should be picked relative to others, and (4) a number of items that need to be picked of each SKU.

In an automated warehouse (e.g., where there is automatic layer picking and/or a manual pick-to-belt operation), a call to determine a pick pallet build operation can also be made at a point that a pick order request is received. However, in a manual pick operation, each build-order for a single pallet can be distinct from other build lines. In the automated pick operation, all layers that have a same build order can be interchangeable while building the pallet. Thus, output from the automated pick operation call can be different than output from the manual pick operation call. Such flexibility in the automated pick operation call can provide for opportunity to determine a best order in which to execute each layer picker task.

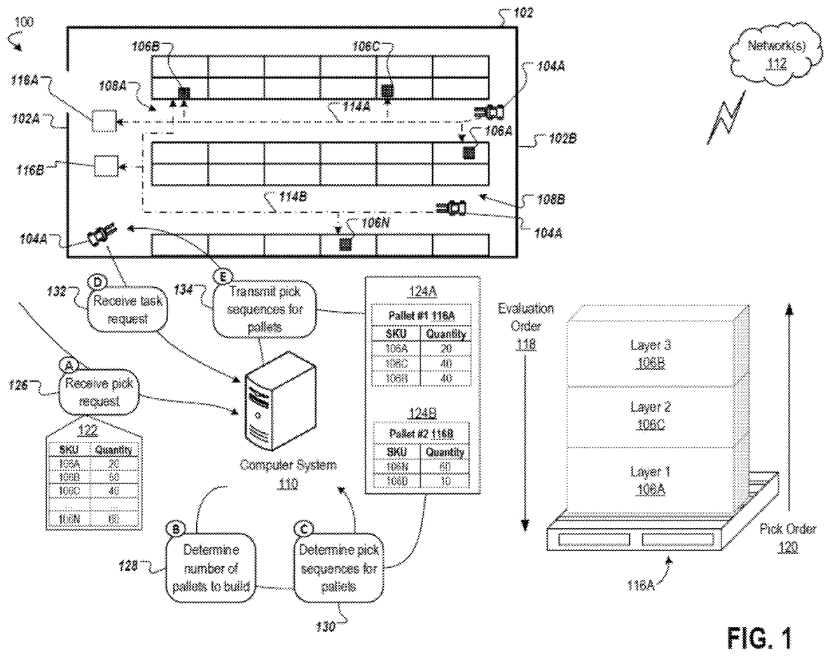

Now referring to the figures, FIG. 1 is a conceptual diagram of a system 100 for determining a pick pallet build operation in a warehouse environment. The example warehouse environment 102 shows a current location of various vehicles, such as forklift 104A, as they move throughout the environment 102. The warehouse environment 102 can include various vehicles that are able to move on their own accord (e.g., the forklift 104A, autonomous vehicles, robots), various warehouse workers who perform operations in the environment 102 and/or control vehicles operating in the environment 102, and various movable objects that can be moved throughout the environment 102, such as pallet items 106A-N. The pallet items 106A-N can be stored throughout the environment 102 and accessible via aisles 108A and 108B.

The items 106A-N can be cases, containers, or boxes of items. The items 106A-N can also be full or partial layers of arranged items. The items 106A-N can be stored and accessible by the aisles 108A-B until such items 106A-N are requested by a customer. A customer, such as a restaurant, store, or other business owner, can request one or more of the items 106A-N to be shipped to them. These items 106A-N can be picked by one or more of the vehicle 104A and arranged into outbound pallets 116A and 116B. Once all the requested items 106A-N are picked and stacked on the pallets 116A-B, the pallets 116A-B can be shipped to the customer.

When building the pallets 116A-B, the vehicle 104A can move from a back 102B of the warehouse environment 102 to a front 102A of the warehouse environment 102. As a result, the pallets 116A-B can be complete, and their heaviest, once at the front 102A of the environment 102, making it easier and less energy or time consuming to move the pallets 116A-B to a docking area or outbound transport vehicles (e.g., trucks, shipping containers).

In order to determine how to build the pallets 116A-B, the vehicle 104A communicates with a computer system 110 via network(s) 112. The computer system 110 can be configured to determine optimal pick pallet build operations, as described herein. The computer system 110 can also be part of a warehouse management system (WMS) and/or the computer system 110 can be in communication with the WMS.

The computer system 110 can receive a pick request (step A, 126). The pick request can be transmitted to the computer system 110 via the WMS. The pick request can also be received from a customer computing device (e.g., mobile phone, smartphone, laptop, computer, tablet). The pick request can include information 122. The information 122 can indicate items that are requested by the customer. In the example of FIG. 1, the information 122 indicates item SKU and quantity of each item being requested. Here, the customer requests 20 of item 106A, 50 of item 106B, 40 of item 106C, and 60 of item 106N. The quantities can be measured as number of cases per item, number of layers per item, number of items, or any other quantity metric. Moreover, the requested items may be listed in no particular order in the information 122.

The computer system 110 can then determine a number of pallets to build (step B, 128). This determination can be made such based on which of the items 106A-N are located in each of the aisles 108A-B. For example, one or more pallets can be built per aisle. This can be advantageous to reduce an amount of travel time for the vehicle 104A. The vehicle 104A may not be required to travel between two aisles while carrying a partially built pallet. Traveling between the two aisles to pick items from the pick request can be time and energy consuming. Instead, as described herein, the vehicle 104A can build one or more pallets per aisle to reduce an amount of travel time and energy needed to pick all the items in the pick request.

As shown in FIG. 1, two pallets can be built, pallets 116A and 116B. Pallet 116A can be built for aisle 108A, which includes items 106A, 106B, and 106C. Pallet 116B can be built for aisle 108B, which includes item 106N. The computer system 110 can determine how many pallets to build based on customer preferences, pallet height thresholds, and/or warehouse standards.

Once the computer system 110 determines a number of pallets to build, the computer system 110 can determine pick sequences for the pallets 116A and 116B (step C, 130). The computer system 110 can identify all source items in the warehouse environment 102 that can fulfill the pick order request and prioritize pick line items. In some implementations, the computer system 110 can try to find as few source items as possible that may satisfy the requested quantities in order to be more computationally efficient. The computer system 110 can also group source items that can be picked based on location. Source items that are closer in location to each other can be grouped together such that the vehicle 104A may not have to travel all over the warehouse 102 to collect the items.

As described throughout this disclosure, the pick sequences can be determined such that the items 106A-N are picked from the back 102B of the warehouse environment 102 to the front 102A of the warehouse 102. This can be advantageous to reduce travel time and energy consumption of the vehicle 104A. As a result, the vehicle 104A can pick items to build more outbound pallets, thereby increasing warehouse efficiency. The items 106A-N can also be ordered within the pick sequences based on how much weight each layer of the items 106A-N can support without being crushed. This can be advantageous to avoid damaging any of the items 106A-N that are requested. For example, item 106B can be bread. Bread can support little weight on top of it without being crushed by that weight. Moreover, since the bread is lightweight, the bread can likely be supported by layers of items that are positioned beneath it without crushing those bottom layers. Thus, the computer system 110 can determine that the bread should be placed in a layer on top of other layered items to avoid crushing the bread.

As described further below, the computer system 110 can determine pick sequences by evaluating the items 106A-N in evaluation order 118. The evaluation order 118 can be a top-down, or front 102A to back 102B, evaluation. In other words, the computer system 110 can select the item 106B from the front 102A of the warehouse 102, place that item 106B on the pallet 116A, and determine whether the item 106B will crush item 106C, which is next closest to the front 102A of the warehouse 102 and the next nearest source item, when the item 106C is placed beneath the item 106B. In the bread example mentioned above, if item 106B is bread and item 106C is cartons of eggs, the computer system 110 can determine that the bread will not crush the eggs if the eggs are positioned beneath the eggs. Thus, the item 106B can be a layer 3 of the pallet 116A build and the item 106C can be a layer 2 of the pallet 116A build. The computer system 110 can then check whether positioning the item 106A as a bottom layer will be able to support both items 106B (layer 3) and 106C (layer 2). For example, item 106A can be boxes of cereal. The computer system 110 can determine that item 106A may not be crushed under the weight of both the bread (layer 3) and the eggs (layer 2). Accordingly, the computer system 110 can determine pick sequence 124A for pallet 116A, as shown in FIG. 1.

The pick sequence 124A lists the items to pick in reverse order from the evaluation order 118. Pick order 120 is in reverse order because the items 106A-N are to be picked from the back 102B to the front 102A of the warehouse 102. Picking the items 106A-N from the back 102B to the front 102A can be advantageous to save energy and gain on speed in building the pallets 116A-B. Moreover, it can be more efficient for the vehicle 104A to carry fewer items by traveling from the back 102B to the front 102A. Thus, where the items 106A-N are evaluated from a top-down approach (e.g., the evaluation order 118), the items 106A-B are actually picked from a back-to-front approach (e.g., the pick order 120). The pick sequence 124A lists a quantity of 20 of item 106A to be picked first because item 106A can make up the bottom layer on the pallet 116A and item 106A is at the back 102B of the warehouse 102. 40 of item 106C are to be picked second to make up the second layer of the pallet 116A. Finally, 40 of item 106B are to be picked up last to make the third layer of the pallet 116A, and item 106B is located at the front 102A of the warehouse 102. The vehicle 104A can travel along route 114A to pick the items 106A, 106C, and 106B in order.

As shown in this example, only 40 of the requested 50 of item 106B can be picked for the pallet 116A. This can occur because the computer system 110 may determine that the pallet 116A, as built using the pick sequence 124A, satisfies a pallet height threshold. The pallet height threshold can be 60 inches. Once the pallet height threshold is satisfied, additional items may not be added to the pallet 116A because then the pallet 116A would be too tall. If the pallet 116A exceeds the pallet height threshold, then the pallet 116A may not be structurally sound. Thus, additional items that may still need to be picked can be sequenced for another pallet build, such as the pallet 124B.

In the example of FIG. 1, pick sequence 124B is determined by the computer system 110 for the pallet 116B. This pick sequence 124B indicates that the vehicle 104A can travel along route 114B in aisle 108B to pick up 60 of item 106N, which is closer to the back 102B of the warehouse 102 than the front 102A. The vehicle 104A can then pick up the remaining quantity of item 106B from the aisle 108A, which is at the front 102A of the warehouse 102. Here, the pallet 116B can be built using partial layers, in which the top layer may not be a full layer of the items 106B and the top layer can include a quantity of leftover items 106B that could not fit into the pick sequence 124A for the pallet 116A. Moreover, as described in reference to determining the pick sequence for the pallet 116A, the computer system 110 can determine that the item 106N can support the weight of the item 106B, the bread, and therefore the item 106N can be placed as a bottom layer of the pallet 116B.

Still referring to FIG. 1, the computer system 110 can receive a task request from the vehicle 104A (step D, 132). In some implementations, the computer system 110 can receive the task request at any time while the computer system 110 is performing steps A-C. The task request can indicate that the vehicle 104A has just finished a task in the warehouse environment 102 or is about to finish a task and is ready to complete a new task.

Accordingly, the computer system 110 can transmit the pick sequences 124A and 124B for the pallets 116A and 116B to the vehicle 104A (step E, 134). The vehicle 104A can then build the pallets 116A-B. The pick sequences 124A and 124B that are transmitted to the vehicle 104A can indicate a sequence for picking and building the items 106A-N, which pallets 116A-B the items 106A-N are to be built on, and the routes 114A-B. The vehicle 104A can therefore receive a sequence of steps that can be followed in order to build the pallets 116A-B.

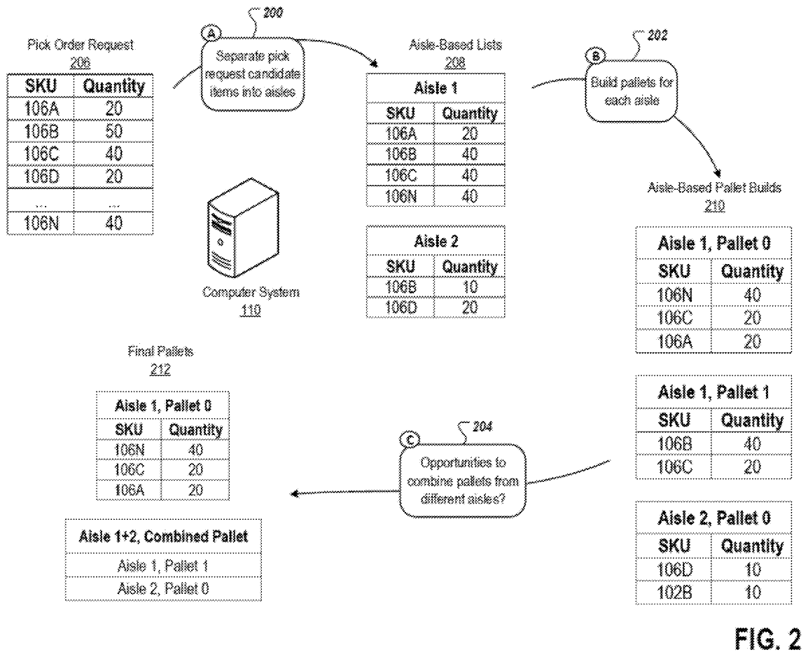

FIG. 2 is a block diagram for determining what pallets to build per aisle in order to fulfill a pick order request. As described herein, this determination can be made by the computer system 110 (e.g., refer to FIG. 1) or any other similar computing system.

The computer system 110 can receive a pick order request list 206. As described herein, the list 206 includes items identified by their SKUs and quantities requested of each item. Here, the list 206 includes 20 of item 106A, 50 of item 106B, 40 of item 106C, 20 of item 106D, and 40 of item 106N.

Using the list 206, the computer system 110 can separate pick request candidate items into aisles (step A, 200). The computer system 110 can identify candidate items throughout the warehouse that can be picked to satisfy the pick order request. The computer system 110 can narrow down which candidate items to pick based on their locations in the warehouse. For example, if several of the items from the list 206 are located within a particular aisle, it can be preferred to build a pallet for that aisle since more of the list 206 can be fulfilled in one pallet build operation. This can be advantageous to reduce an amount of time required to fulfill the pick order request. In the example of FIG. 2, the computer system 110 can generate aisle-based lists 208.

The lists 208 indicate that aisle 1 contains 20 of item 106A, 40 of item 106B, 40 of item 106C, and 40 of item 106N. Aisle 2 contains 10 of item 106B and 20 of item 106D. These aisles can be selected for building the pick pallets since these aisles can have the closest full quantities of the items requested in the list 206. For example, aisle 1 contains the full requested quantities of items 106A, 106C, and 106N. Picking the full requested quantities in one pallet build operation can be advantageous to reduce an amount of time needed to fulfill the pick order request. It can be more advantageous than moving around the warehouse to pick up the items 106A-N in locations that are not proximate to each other.

Once the aisle-based lists 208 are generated, the computer system 110 can build pallets for each aisle using such lists 208 (step B, 202). Using the techniques described herein, the computer system 110 can identify aisle-based pallet builds 210. In this example, the computer system 110 determined that 3 pallets can be built. In aisle 1, a pallet identified as pallet 0 can be built with 40 of item 106N, 20 of item 106C, and 20 of item 106A. In aisle 1, another pallet identified as pallet 1 can be built with 40 of item 106B and 20 of item 106C. In aisle 2, a pallet identified as pallet 0 can be built with 10 of item 106D and 10 of item 102B.

The aisle-based pallet builds 210 can list the items 106A-N in an order in which they can be picked. Therefore, to build pallet 0 in aisle 1, the item 106N can be picked first, the item 106C can be picked second, and the item 106A can be picked last. As described herein, the items 106A-N can be picked from a back to a front of the warehouse, even though the items 106A-N are evaluated for picking from the front to the back of the warehouse. Thus, item 106N can be located near the back of the warehouse in aisle 1 whereas the item 106A can be located near the front of the warehouse in aisle 1.

After the computer system 110 generates the aisle-based pallet builds 210, the computer system 110 can determine whether there are opportunities to combine pallets from different aisles (step C, 204). The opportunities to combine can exist where one or more pallets per aisle can be built but are not full. In other words, the one or more pallets can include full or partial layers of items. The one or more pallets can also have a height that is less than a maximum height that the pallet can be.

Accordingly, the computer system 110 can generate final pallets list 212. The list 212 can indicate full pallets per aisle and/or pallets that can be combined from different aisles. In the example of FIG. 2, the computer system 110 identified an opportunity to combine the pallet 1 from aisle 1 with the pallet 0 from aisle 2. The list 212 therefore can indicate that a first pallet can be built in aisle 1 as pallet 0 and a second, combined pallet can be built to include pallet 1 from aisle 1 and pallet 0 from aisle 2. The resulting two pallets can be the final pallets shipped to a customer in order to fulfill the customer's pick order request.

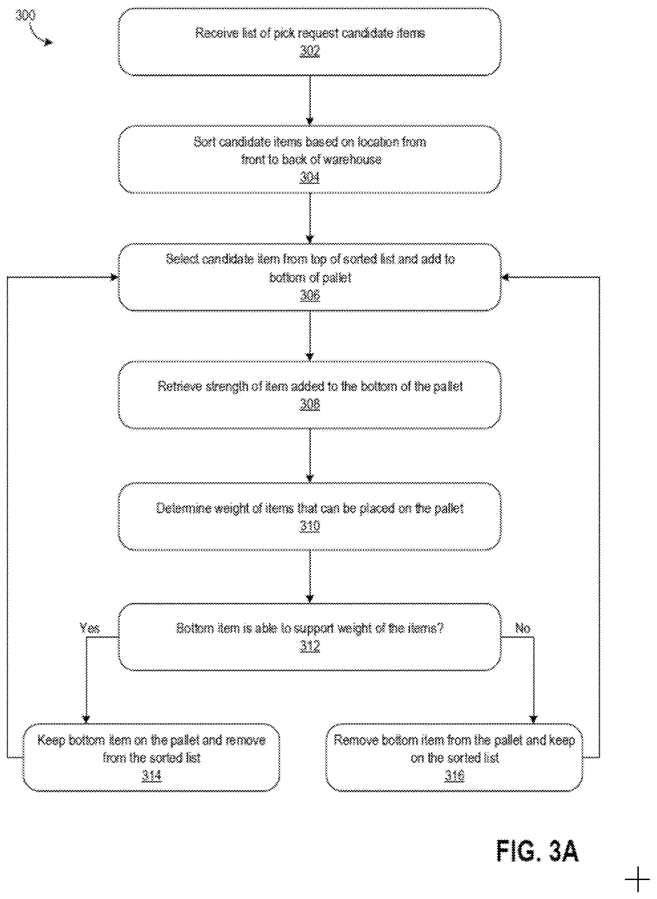

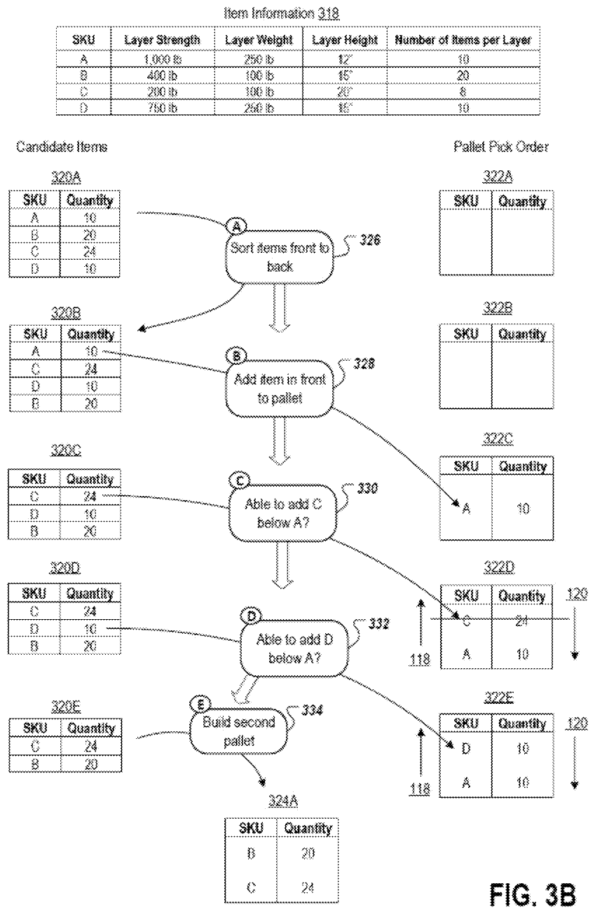

FIG. 3A is a flowchart of a process 300 for determining a pick sequence for an aisle pallet. FIG. 3B is a block diagram for determining the pick sequence of FIG. 3A. The process 300 can be performed by the computer system 110 described herein. One or more blocks of the process 300 can also be performed by other computer systems, servers, and/or devices. For illustrative purposes, the process 300 is described from a perspective of a computer system.

Referring to the process 300 in FIG. 3A, the computer system can receive a list of pick request candidate items in 302. As shown in FIG. 3B, a candidate items list 320A includes items listed by their SKU and requested quantity. The list 320A indicates that 10 of item A are requested, 20 of item B are requested, 24 of item C are requested, and 10 of item D are requested. At a time that the list 320A is received, the computer system may not have a pallet pick order 322A determined. The pallet pick order can be populated/updated as the computer system continues through the process 300.

When the list 320A is received in 302 (refer to FIG. 3A), the computer system can also receive item information 318. The item information 318 can be received from a customer computing device. For example, the customer making a pick order request can transmit the item information 318 with the request. In some implementations, the item information 318 can be retrieved or received from a warehouse management system (WMS) once the pick order request is received at the warehouse.

The item information 318 can include information about each of the items that are requested to fulfill the pick order request. For each requested item, the item information 318 can include layer strength, layer weight, layer height, and a number of items per layer. The information 318 can include additional or fewer details for each of the requested items. In the example of FIG. 3B, the item information 318 indicates that item A has a layer strength of 1,000 lb, a layer weight of 250 lb, a layer height of 12″, and 10 items per layer. Thus, a layer of item A can support up to 1,000 lb placed on top of it. A layer of 10 items weighs 250 lb, and the layer has a maximum height of 12 inches. The item information 318 indicates that item B has a layer strength of 400 lb, a layer weight of 100 lb, a layer height of 15″, and 20 items per layer. Item C has a layer strength of 200 lb, a layer weight of 100 lb, a layer height of 20″, and 8 items per layer. In comparison to item A, item C can support 800 lb less weight than item A. Finally, the item information 318 indicates that item D has a layer strength of 750 lb, a layer weight of 250 lb, a layer height of 15″, and 10 items per layer. The item information 318 can include one or more additional information about the items. For example, the information 318 can indicate length and width dimensions, gross item weight, net item weight, and/or measurements of a full pallet.

Referring to the process 300 in FIG. 3A, the computer system can sort the candidate items based on location from front to back of the warehouse in 304 (refer to step A, 326, in FIG. 3B). As shown in FIG. 3B, an updated candidate items list 320B can be generated by the computer system. Item A can be located at a front of the warehouse, item C can be located next closest to item A and the front of the warehouse, item D can be located next closest to item C and the front of the warehouse, and item B can be located farthest away from the front of the warehouse (e.g., at the back of the warehouse). At this point in the process 300, pallet pick order 322B may still be empty/not yet determined.

To determine an optimal pick sequence, the computer system can start by selecting a candidate item from the top of the sorted list and adding that candidate item to a bottom of a pallet build in 306 (refer to step B, 328, in FIG. 3B). As shown in FIG. 3B, item A, which is at the top of the candidate items list 320B, can be selected as a bottom layer in the pallet pick order 322C.

The computer system can then retrieve strength information for the item added to the bottom of the pallet in 308. For example, the computer system can access the item information 318 and identify that item A has a layer strength of 1,000 lb and a layer weight of 250 lb (refer to FIG. 3B). Since 10 of item A are requested and one layer contains 10 items, the computer system can determine that only one layer of item A can be added to the bottom of the pallet.

Next, the computer system can determine a weight of items that can be placed on the pallet in 310. The computer system can determine this using the item information 318. For example, the computer system can determine that one layer of the item A weighs 250 lb.

The computer system can determine whether the bottom item is able to support the weight of the other items in 312 (refer to step C, 330, in FIG. 3B). Thus, as shown in FIG. 3B, the computer system can determine whether the item C, which is next nearest to item A, can support the weight of item A (refer to candidate items list 320C). One layer of item C has a maximum layer strength of 200 lb, but the weight of one layer of item A has been identified as 250 lb. Therefore, the computer system can determine that item C cannot support the weight of item A without being damaged or crushed. Pallet pick order 322D has been updated to show that item C, although added on top of item A in the evaluation order 118, cannot sustain the weight of item A if picked in the pick order 120. Thus, the item C is crossed off and removed from pallet pick order 322E.

If the computer system determines that the bottom item is able to support weight of the item(s) placed above it, then the computer system can keep the bottom item on the pallet and remove that item from the sorted list in 314. The computer system can return to block 306 and repeat 306-312 until a structurally sound pallet is built with the candidate items.

If the bottom item cannot support the weight, then the computer system can remove the bottom item from the pallet and keep that item on the sorted list in 316. The computer system can return to block 306 and repeat 306-312 until a structurally sound pallet is built with the candidate items. As shown in the pallet pick order 322D in FIG. 3B, item C cannot support the weight of item A. Thus, item C is removed from pallet pick order 322E and kept on candidate list 320D.

The computer system can evaluate the next nearest item to item A, which is item D. The computer system can evaluate placing item D below item A, as shown in the pallet pick order 322E, to determine whether item D can be added below item A (step D, 332). As described above, the computer system can determine whether item D, which can support up to 750 lb, is able to support the 250 lb of item A without being crushed. Since the item D can support the weight of item A, item D can be kept in the pallet pick order as an item to pick before item A in the pick order 120.

Item D can be removed from candidate items list 320E, which now includes only items C and B. The computer system can determine that a second pallet needs to be built with the remaining items C and B. This determination can depend on whether the first pallet built using the pallet pick order 322E can be at a maximum height threshold, whether adding any additional layers to the first pallet can cause the first pallet to exceed the maximum height threshold, and/or whether the combination of layers of items D and A can support any additional weight without being crushed. Thus, the computer system can build the second pallet using the techniques described herein (step E, 334). A pallet pick order 324A can be generated for the second pallet.

In the example of FIG. 3B, the pallet pick order 324A indicates that item B can be picked first, which is closer to the back of the warehouse than item C, and used as a bottom layer for the second pallet. Since each layer of item C contains 8 items, 3 layers of item C can be required. 3 layers of item C can weigh 300 lb (refer to the item information 318). One layer of item B has a layer strength of 400 lb. Thus, the layer of item B can support the weight of 3 layers of item C without being crushed. As a result, the second pallet can be built from the back of the warehouse to the front of the warehouse, by placing the layer of item B on the bottom of the pallet and the 3 layers of item C on top of the layer of item B.

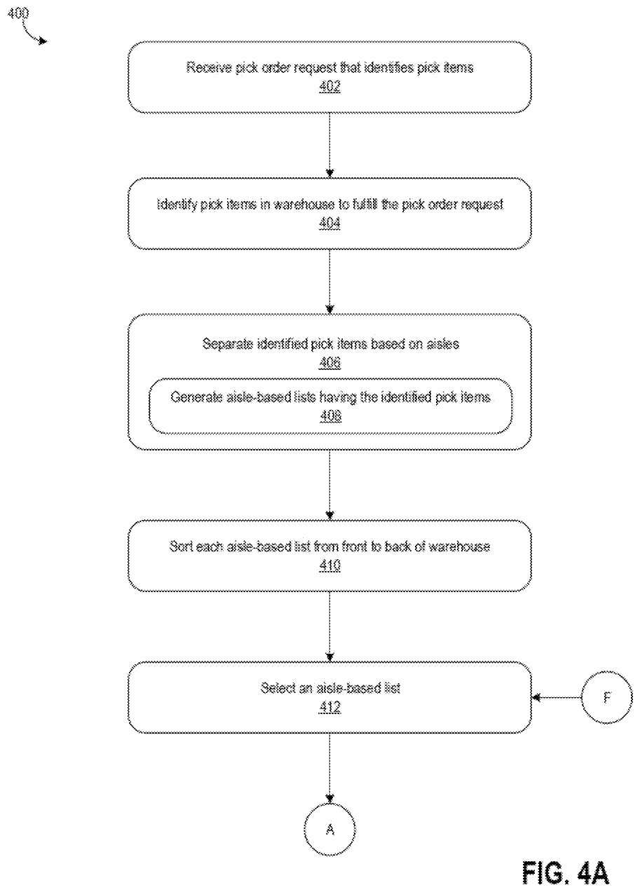

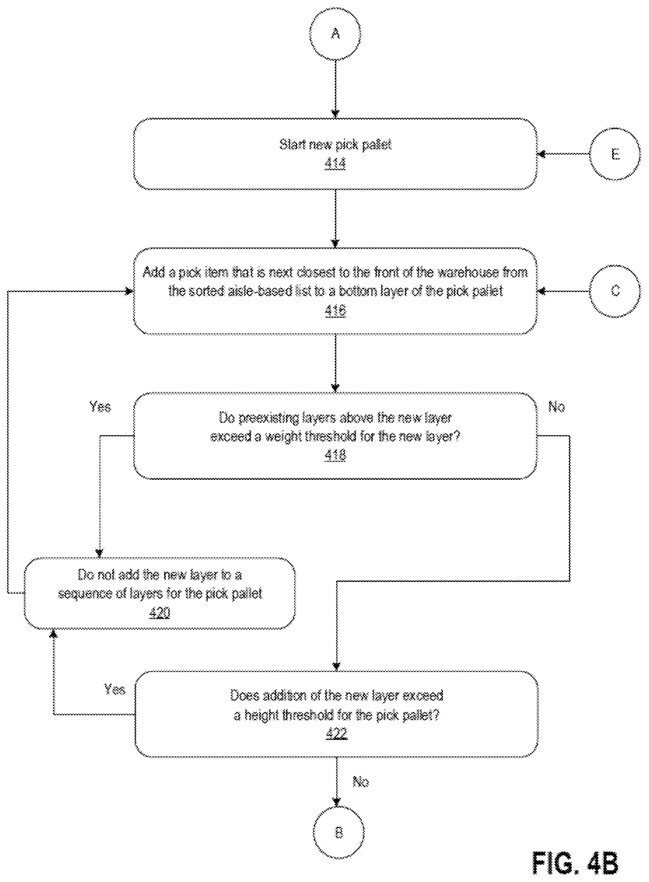

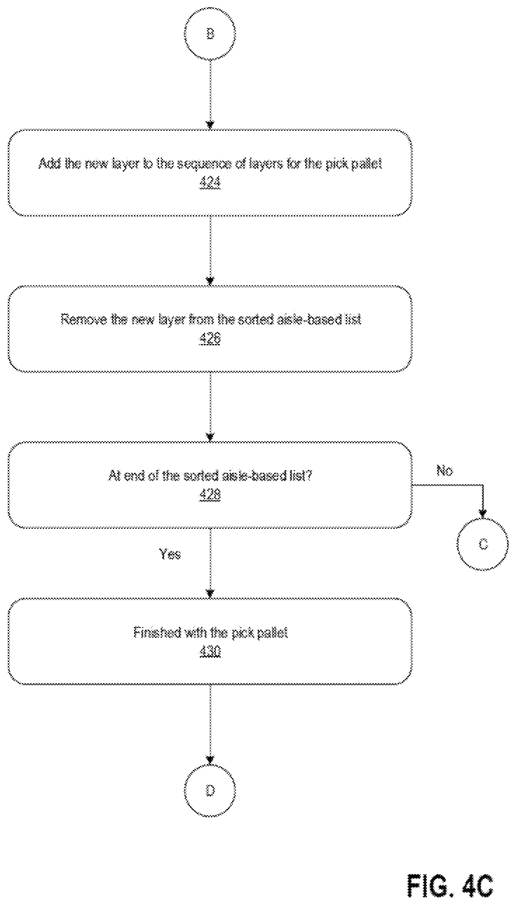

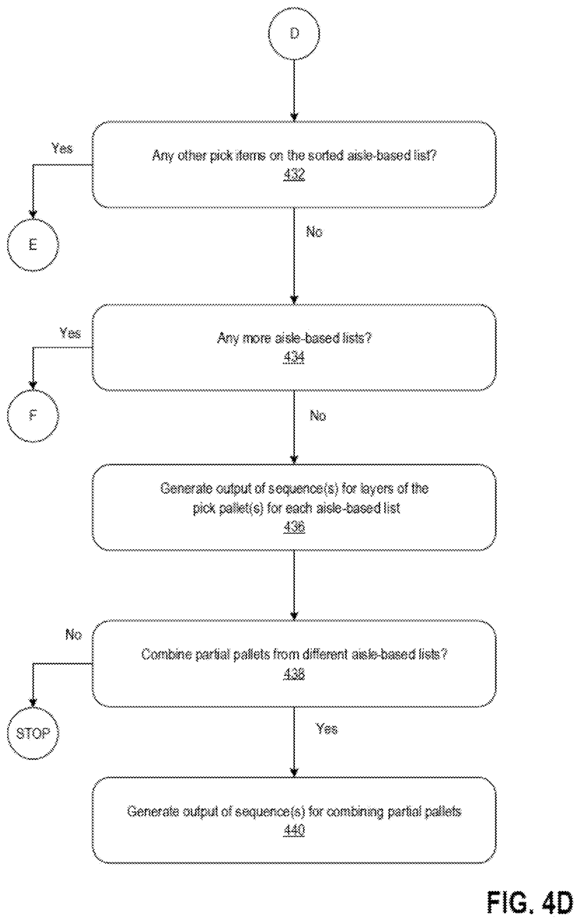

FIGS. 4A-D is a flowchart of a process 400 for determining an optimal pallet build using the techniques described herein. The process 400 can be performed by the computer system 110 described herein. One or more blocks of the process 400 can also be performed by other computer systems, servers, and/or devices. For illustrative purposes, the process 400 is described from a perspective of a computer system.

Referring to the process 400 depicted in FIGS. 4A-D, the computer system can receive a pick order request that identifies items to be picked in 402. The pick order request can include an order number, an owner identifier, item(s) identifier(s), quantity of each requested item, a flag indication of whether mixing the owner with other owners is allowed, and any temperature or other storage conditions. The pick order request can also identify any constraints, such as a pallet type, maximum width, maximum height, maximum weight, and/or a rush order indicator.

The computer system can identify pick items in the warehouse that can be used to fulfill the pick order request in 404. As described herein, the computer system can identify items that are closest to each other in location in the warehouse. Items that are closer together can be picked in less time and with less travel, which can improve warehouse efficiency. In identifying the items that can be picked, the computer system can also identify, for each item, an owner identifier, item identifier, identifier date (e.g., if the item is on a pick line), location name, temperature zone, storage conditions, platform type (e.g., CHEP, GMA, EUR, etc.), case/item quantity, an indication of whether the item is on a pick line, and/or an indication of whether the item must be used first in a pallet build to satisfy a pick.

Next, the computer system can separate the identified pick items based on aisles that they are located within (406). The computer system can generate aisle-based lists having the identified pick items in 408. As described herein, one or more pallets can be built per aisle. The one or more pallets can be built in the aisle from a back of the warehouse to a front of the warehouse in order to improve travel time, energy usage, and overall pallet build operations.

Each aisle-based list can be sorted from front to back of the warehouse in 410. Thus, the identified pick items in each aisle can be sorted such that an item at a top of the aisle-based list is located at a front of the aisle that is closest to the front of the warehouse and an item at a bottom of the aisle-based list is located at a back of the aisle that is closest to the back of the warehouse. As described throughout this disclosure, a pallet can be built from the back to the front of the warehouse, however the computer system can evaluate an order to pick the items to build the pallet in reverse order, from the front to the back of the warehouse.

Still referring to the process 400 in FIGS. 4A-D, the computer system can select one of the sorted aisle-based lists in 412. Once the list is selected, the computer system can start a new pick pallet in 414. The computer system can then determine how to sequence items within the aisle on the new pick pallet. For example, the computer system can add a pick item that is next closest to the front of the warehouse from the sorted aisle-based list to a bottom layer of the pick pallet (416). The computer system can add a first item closest to the front of the warehouse to the bottom layer. If an item is already on the pallet, then the computer system can add a next item closest to the front of the warehouse to the bottom layer.

The computer system can determine whether preexisting layers above the new layer exceed a weight threshold for the new layer in 418. The computer system can determine whether the new layer can support the weight of the preexisting layers. As described herein, each layer can have a maximum amount of weight that it can support. When layers exceeding that maximum weight are placed on top of the layer, the layer can be damaged and/or crushed.

Therefore, if the computer system determines that preexisting layers above the new layer would exceed the maximum weight threshold for the new layer in 418, the computer system can determine that the new layer should not be added to a sequence of layers for the pick pallet in 420. The computer system can return to block 416. The computer system can repeat blocks 416-418 for a next pick item closest to the first item that was evaluated and the front of the warehouse.

If, on the other hand, the computer system determines that the preexisting layers above the new layer do not exceed the weight threshold for the new layer in 418, then the computer system can determine that the new layer can potentially be placed beneath the preexisting layers without being crushed or otherwise damaged. Thus, the computer system can determine whether addition of the new layer would exceed a height threshold for the pick pallet in 422. The height threshold can be set in the pick order request. The height threshold can be based on customer preferences and/or warehouse standards. As an example, the height threshold can be 60 inches.

If adding the new layer would cause the pick pallet to exceed the height threshold, then the computer system can return to block 420. After all, the new layer should not be added to the pick pallet. If, on the other hand, adding the new layer would not cause the pick pallet to exceed the height threshold, the computer system can add the new layer to the sequence of layers for building the pick pallet in 424.

Once the new layer is added to the sequence of layers, the new layer can be removed from the sorted aisle-based list in 426. The computer system can determine whether it has reached an end of the sorted aisle-based list in 428. In other words, the computer system can determine whether it has evaluated each item in the aisle-based list and/or added each item to the sequence of layers for the pick pallet.

If the computer system has not reached the end of the sorted aisle-based list, then the computer system may evaluate one or more items still remaining on the list. Thus, the computer system can return to block 416. The computer system can add a new item at the top of the list to a bottom layer of the pick pallet and perform the evaluation in blocks 418-428 for that new item. The computer system can repeat blocks 416-428 until the computer system has reached the end of the sorted aisle-based list.

If the computer system has reached the end of the sorted aisle-based list, then the computer system can determine that it has finished the pick pallet in 430. In other words, a pick order sequence has been determined for the particular pick pallet, which includes items from the sorted aisle-based list.

The computer system can then determine whether there are any additional pick items on the sorted aisle-based list in 432. In some implementations, the finished pick pallet may not include all of the items that are on the aisle-based list. This scenario can occur when the finished pick pallet is at the maximum height threshold and/or the layers of the finished pick pallet cannot support any additional weight. Thus, one or more additional pallets may be built for the particular aisle with any additional pick items in that aisle.

If there are other pick items on the sorted aisle-based list that have not been included in the finished pick pallet in 432, then the computer system can return to block 414 and start a new pick pallet. The computer system can repeat blocks 414-432 until all of the additional items in the sorted aisle-based list are arranged into pallet build sequences.

If there are no other pick items on the sorted aisle-based list, then the computer system can determine whether there are any more aisle-based lists in 434. If there are more aisle-based lists, the computer system can return to block 412 and select another of the aisle-based lists. The computer system can then repeat blocks 412-434 until there are no more aisle-based lists to build pallets with.

If there are no more aisle-based lists in 434, then the computer system can determine that the pick order request can be completed. After all, all the items in the request have been arranged in pallet build sequences. The pallets can therefore be built using the pallet build sequences determined in blocks 412-434. Accordingly, the computer system can output sequence(s) for layers of the pick pallet(s) for each aisle-based list in 436. As described herein, in some implementations, the computer system can generate one pallet build sequence per aisle. In some implementations, the computer system can generate multiple pallet build sequences per aisle.

The output generated in 436 can include an order number associated with the pick order request, a set of pallets to build for the pick order request, and steps or instructions for building the pallets. For each of the pallets to build, the output can include SKUs for items going on the pallet, locations of each SKU, a pick/build order, a number of items/cases to pick for each SKU, any required equipment to build the pallet, and/or an estimated height of the pallet once built.

The computer system can also determine whether to combine partial pallets from different aisle-based lists in 438. In some implementations, a pallet can be built for an aisle with any remaining items that did not fit onto a first pallet for that aisle. This can result in a partial pallet. The partial pallet may not have full layers. In some implementations, the partial pallet may have full layers but may not be at a maximum height for the pallet. Thus, additional layers and/or items can be added to the partial pallet.

If the computer system determines that there are no partial pallets from the different aisle-based lists that can be combined in 438, the process 400 can stop. In some implementations, one or more of the aisle-based lists can include partial pallets, however the partial pallets may not be able to be combined because a final combined pallet may exceed a maximum height threshold for the pallet. In some implementations, the partial pallets may not be combined because one or more of the pallets may not be able to sustain the weight of the other pallets. As a result, one or more of the pallets may be damaged or otherwise crushed. Combining the partial pallets can therefore compromise pallet structural integrity.

However, if the computer system determines that partial pallets from one or more of the different aisle-based lists can be combined, then the computer system can generate output of sequence(s) for combining the partial pallets in 440. The output can indicate a sequence to layer the partial pallets into a final pallet. The output can also indicate a set of coordinates indicating where each partial layer and/or loose item can be placed on the pallet. The coordinates can, for example, start with (0, 0) in a lower left corner of the pallet from a perspective of a warehouse worker or warehouse vehicle building the pallet.

The output can from blocks 436 and 40 can be provided to a warehouse vehicle and/or a device of a warehouse worker. As described in reference to FIG. 1, the output can be provided when the warehouse vehicle and/or the warehouse worker request to start a new task.

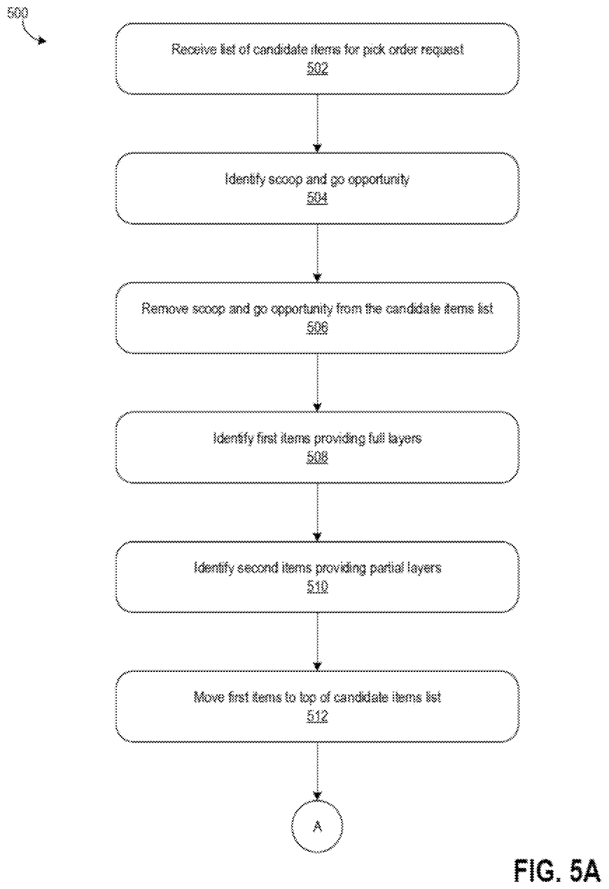

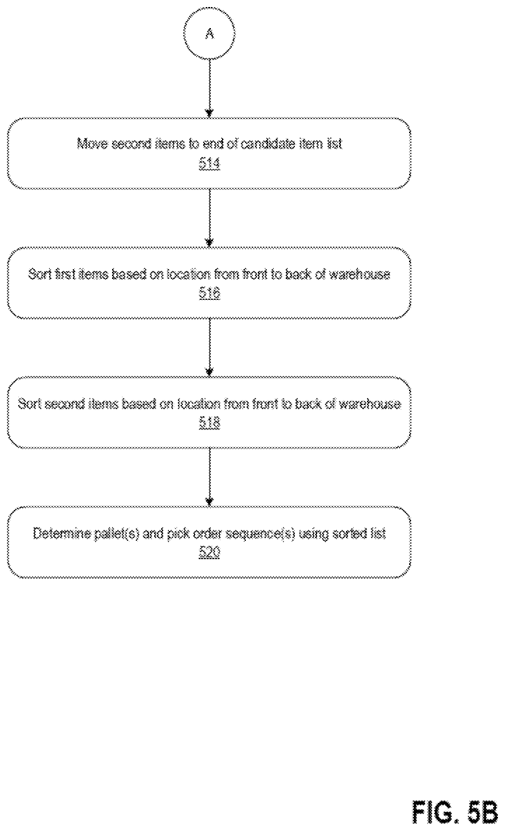

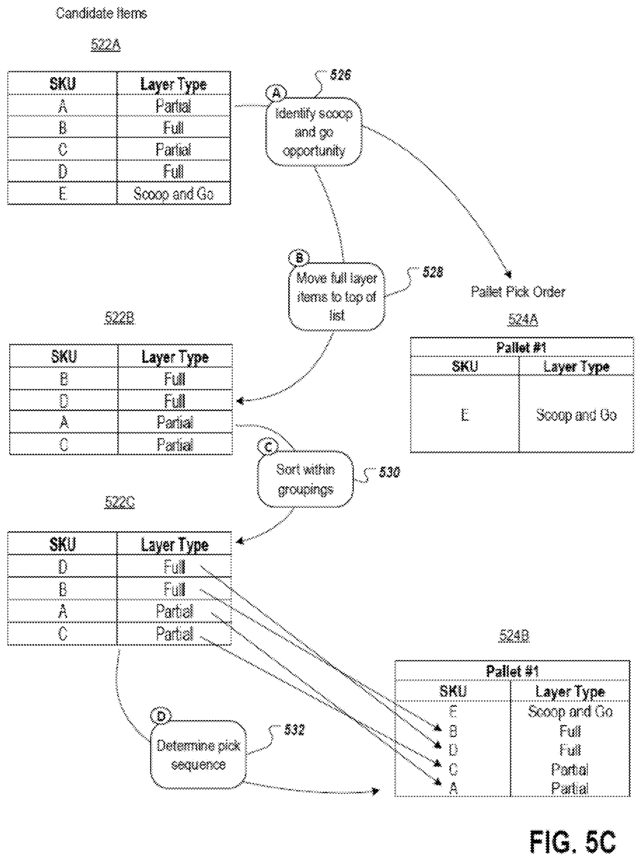

FIGS. 5A-B is a flowchart of a process 500 for determining an optimal pallet build using scoop and go, full, and partial layers. The process 500 can be performed by the computer system 110 described herein. One or more blocks of the process 500 can also be performed by other computer systems, servers, and/or devices. For illustrative purposes, the process 500 is described from a perspective of a computer system. FIG. 5C is a block diagram for determining the optimal pallet build of FIGS. 5A-B.

Referring to the process 500 in FIGS. 5A-C, the computer system can receive a list of candidate items for a pick order request in 502. As shown in FIG. 5C, candidate items list 522A can indicate items to be picked based on their SKU (e.g., identifier, barcode, label, QR code). The candidate items list 522A can also indicate a layer type for each of the candidate items. For example, item A is a partial layer, item B is a full layer, item C is a partial layer, item D is a full layer, and item E is a scoop and go layer.

The computer system can identify a scoop and go opportunity in 504 (refer to step A, 526, in FIG. 5C). A scoop and go opportunity can exist when a number of cases or items needed from a source pallet is greater than 50% of a total number of cases on that source pallet. Scoop and go opportunities can also exist in a variety of different scenarios, for example, when the number of cases or items needed from the source pallet is greater than 50%, 40%, 30%, 20%, 10%, 5%, etc. of a quantity remaining on the source pallet. As another example, each physical mixed pallet build can have at most one scoop and go item. However, there often can be multiple potential scoop and go items for a particular mixed pallet. In such scenarios, the computer system can identify an order line item with a highest quantity, and select that item as the scoop and go opportunity. As an illustrative example, if source pallet A has 50 cases on it and the mixed pallet needs 30, and source pallet B has 100 cases on it and the mixed pallet needs 60, the computer system can choose source pallet B as the scoop and go opportunity. Selecting source pallet B can be advantageous to minimize a number of cases that have to be moved on the source pallet B to build the mixed pallet, in comparison to moving cases on the source pallet A to build the mixed pallet.

Selecting the scoop and go opportunity as a base or bottom layer for a pallet can be advantageous because it can reduce an amount of time, energy, and need to move around the warehouse in order to collect additional quantities of the requested item. Therefore, identifying a scoop and go opportunity can improve warehouse efficiency by reducing travel and build time.

If a scoop and go opportunity is identified, the scoop and go opportunity can be used to build the pallet, as shown in pallet pick order 524A in FIG. 5C. Thus, the scoop and go opportunity can be used as a base or bottom layer for the pallet. Item E is identified as a scoop and go opportunity because item E has a quantity of items (e.g., cases) needed from a source pallet that is at least or greater than 50% of a quantity of the item E on that source pallet. Item E can remain as the bottom layer of the pallet, even though sequencing of layers above this scoop and go item can change.

In some implementations, there may not be a scoop and go opportunity. In such scenarios, the computer system can proceed to block 508.

Once the scoop and go opportunity is identified in 504, the computer system can remove the scoop and go opportunity from the candidate list in 506. As shown in FIG. 5C, candidate list 522B can therefore be updated to include items A-D.

Next, it can be easier and more efficient to build a pallet with full layers on top of each other rather than with layers of varying heights and sizes. It can be preferred to sequence full layers above the scoop and go bottom layer and then partial layers on top of the full layers. Accordingly, the computer system can identify first items that provide full layers in 508. The computer system can also identify second items that provide partial layers in 510. The computer system can then move the first items to a top of the candidate items list in 512 (refer to step B, 528, in FIG. 5C). Similarly, the computer system can move the second items to an end of the candidate item list (514). As shown in FIG. 5C, the candidate items list 522C includes the items B and D at the top of the list 522C, since they are full layers. The items A and C have been moved to the end of the list 522C because they are partial layers.

The computer system can sort the first items based on their location from a front to a back of the warehouse in 516. The computer system can also sort the second items based on their location from the front to the back of the warehouse in 518 (refer to step C, 530, in FIG. 5C). The items can be sorted within their groupings because, as described throughout this disclosure, building a pallet from the back to the front of the warehouse can improve warehouse efficiency, reduce travel time, and reduce time needed to build the pallet.

Using the sorted list of candidate items, the computer system can determine pallet(s) and pick order sequence(s) in 520, as described throughout this disclosure (refer to FIGS. 2-4). Therefore, the computer system can first determine pallet build sequences for the full layers. The computer system can then determine pallet build sequences for the partial layers (refer to step D, 532, in FIG. 5C).

As demonstrated in FIG. 5C, the computer system can determine pallet pick order 524B. Item E can be picked first since it is the scoop and go opportunity. Item B can be picked next and layered on top of the item E since item B is a full layer and can support weight of the items D, C, and A. Item D can then be picked and layered on top of the item B since item D is a full layer and can support weight of the items C and A. Item C can be picked next and layered on top of item D because there are no remaining full layers to sequence. Of the partial layers, item C can be layered above item D and beneath item A because item C can support weight of the item A. Finally, item A can be layered on a top of the pallet since it is the last remaining partial layer and is a weight that can be supported by the items E, B, D, and C. As a reminder, items such as item E and B can also be closest to the back of the warehouse while item A can be located closest to the front of the warehouse. The pallet pick order 524B therefore can ensure that the pallet is built efficiently from the back to the front of the warehouse while using minimum travel time and energy.

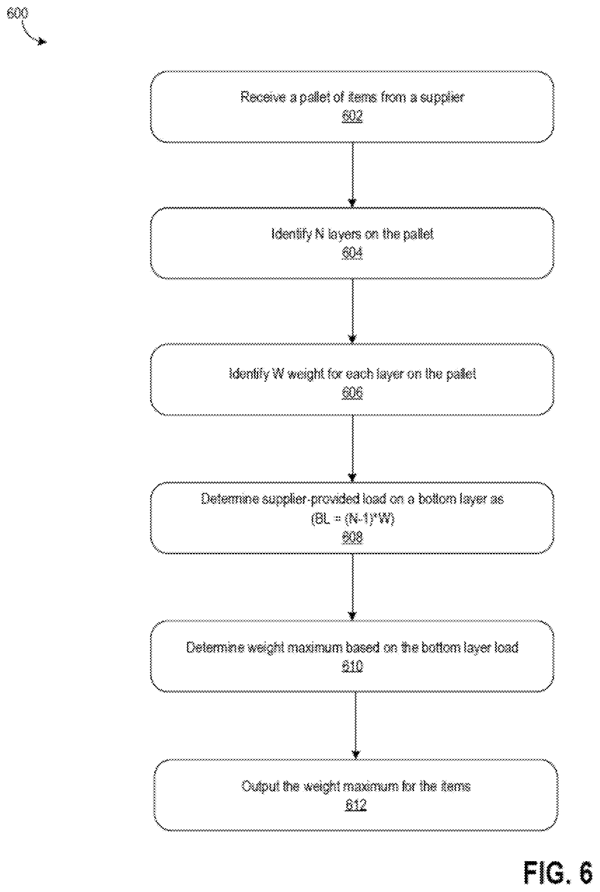

FIG. 6 is a flowchart of a process 600 for determining a maximum amount of weight that a layer can support. The maximum amount of weight can be inferred based on available data, as described further below. In some implementations, the process 600 can be performed at one time for a layer of items. For example, the process 600 can be performed when the layer of items first arrives at the warehouse. In some implementations, the process 600 can be performed at predetermined times in order to determine whether conditions of the layer of items have changed in such a way that can alter the maximum amount of weight that the layer can support. The determined maximum amount of weight can then be stored and used for any pick order request that request such items. The process 600 can be performed by the computer system 110 described herein. One or more blocks of the process 600 can also be performed by other computer systems, servers, and/or devices. For illustrative purposes, the process 600 is described from a perspective of a computer system.

Referring to the process 600, the computer system can receive a pallet of items from a supplier in 602. The supplier can send a same quantity of items on each pallet over time. In such scenarios, the process 600 can be performed once when a pallet is received instead of every time that a pallet is received from the supplier. In some implementations, the supplier can send pallets having different quantities of the item and/or number of layers of the item. In such scenarios, the computer system can take a maximum or average of the received pallets in order to perform the process 600. When the pallet of items is received from the supplier, the computer system can also receive an SKU or other identifier used to identify the items on the pallet. In some implementations, the computer system can receive additional information, such as a size of each item on the pallet, a weight of each item on the pallet, and storage conditions for the pallet.

The computer system can then identify N number of layers on the pallet in 604. In some implementations, the computer system can receive information from the supplier indicating the number of layers on the pallet. In some implementations, the number of layers can be inferred using imaging techniques. For example, images of the pallet can be captured once the pallet enters the warehouse. Using image processing techniques, the computer system can determine how many layers appear in the image data. In some implementations, a warehouse worker can count the number of layers and provide that count to the computer system.

The computer system can identify W weight for each layer on the pallet in 606. As mentioned, the weight information can be provided to the computer system by the supplier. For example, the computer system can receive information indicating weight of each item on the pallet. The computer system can also receive information indicating a total quantity of the items on the pallet. The computer system can multiply the weight for each item with the total quantity of the items to determine an overall weight. The overall weight can be divided by the N number of layers to determine W weight per layer. In some implementations, the pallet can be weighed upon arrival at the warehouse. The computer system can receive this weight value, divide it by the N number of layers, and subtract a weight of the pallet structure itself to determine the W weight per layer. In some implementations, the computer system can receive the W weight per layer from the supplier and/or a warehouse management system (WMS).

Next, the computer system can determine a supplier-provided load on a bottom layer in 608. This load can be identified using an equation as follows: (N−1)*W. The computer system can therefore determine how much weight the supplier had loaded on top of the bottom layer on the pallet. This load can be used to determine how much weight any of the layers can support without being damaged or otherwise crushed. After all, if the bottom layer can support weight of all layers above it, then any of the layers can support a maximum of whatever weight was placed on top of the bottom layer.

As a simple example, a pallet can have 5 layers and each layer can weigh 100 lb. A bottom layer, layer 1, can have a supplier-provided load of (5−1)*100, which amounts to 400 lb. Thus, the bottom layer, layer 1, can support 400 lb without being damaged or otherwise crushed. If a top layer on the pallet, layer 5, is switched with layer 1 to become the new bottom layer, then the layer 5 can also support 400 lb without being damaged or crushed, since every layer's load can be inferred as the same.

Accordingly, the computer system can determine a weight maximum based on the bottom layer load in 610. The computer system can determine how much weight any of the layers on the pallet can support without being crushed. The computer system can also determine the weight maximum within a margin parameter. For example, the computer system can multiply the bottom layer load by a weighted margin multiplier to represent a maximum amount of weight that can be placed on top of the layer. In some implementations, the weighted margin multiplier can be 1.2 or some value that is less than 2.0. In some implementations, the weighted margin multiplier can be a percentage. For example, the multiplier can be no more than 10-20% more than the supplier-provided load.

The computer system can then output the weight maximum for the items in 612. Each item on the pallet can have the same weight maximum, as described above. The weight maximum can be used in subsequent processes to determine how much weight a layer of the item can support without being damaged or otherwise crushed.

The process 600 can be advantageous because it does not require actually crushing the layer of items in a field test. The process 600 can also be used to dynamically adjust how much weight the layer of items can support based on how packaging or other characteristics of that layer may change over time. Adjusting the output from the process 600 may not require the entire process 600 to be repeated. Instead, only one or more of the blocks 602-612 can be performed in order to update the determined weight maximum for the items.

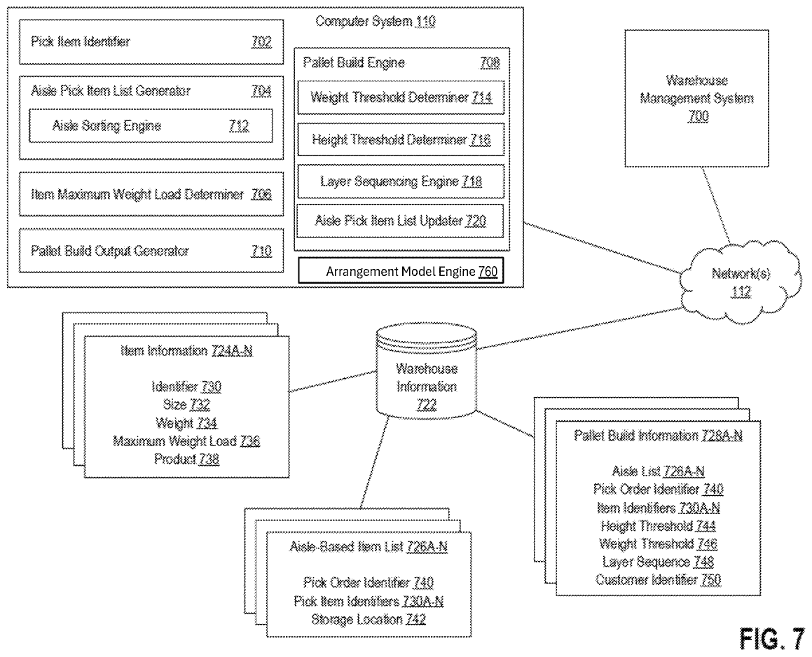

FIG. 7 is a system diagram of one or more components used to perform the techniques described herein. As described herein, the computer system 110 can communicate with one or more components, computing systems, servers, and/or data stores via the network(s) 112 (e.g., wired and/or wireless communication), including warehouse management system (WMS) 700 and warehouse information data store 722. In some implementations, the computer system 110 and the WMS 700 can be a same computer system, network of computers, and/or server(s).

The WMS 700 can be configured to perform operations that manage the warehouse. For example, the WMS 700 can receive information about inbound and outbound items and pallets. The WMS 700 can receive pick order requests, put away orders, and other operations within the warehouse. The WMS 700 can be configured to update information that is stored in the warehouse information data store 722. The WMS 700 can also make determinations about where to store items in the warehouse, profiling items, and assigning tasks to warehouse workers and warehouse vehicles. The WMS 700 can perform one or more other operations that are associated with managing tasks and actions within the warehouse.

In some implementations, the WMS 700 can receive a pick order request. The WMS 700 can transmit the request to the computer system 110. In some implementations, the computer system 110 can receive the pick order request from a customer computing device.

The computer system 110 can be configured to determine optimal pick pallet build operations as described herein. The computer system 110 can include a pick item identifier 702, an aisle pick item list generator 704, an item maximum weight load determiner 706, a pallet build engine 708, and a pallet build output generator 710.

The pick item identifier 702 can be configured to determine which items in the warehouse can be picked to fulfill a pick order request (e.g., refer to block 404 in FIG. 4A). The identifier 702 can identify source pallets containing the items to be picked to fulfill the request. The identifier 702 can also identify locations of such source pallets. The identifier 702 can be configured to identify source pallets having a greatest quantity of the requested items and source pallets that are closest to each other in location. As a result, a pallet can be built more efficiently. A warehouse vehicle may pick up the items that are closest to each other instead of traveling all over the warehouse to various different locations to collect the items. Since the items can be picked up close to each other, less energy can be used to transport the pallet around the warehouse. Additionally, since the items can be picked up close to each other, building the pallet can require less time. Picking up items that are closest in quantity to the requested item quantities can also be advantageous so that the pallet can be built with as many full layers as possible. The more full layers, the fewer partial layers and the fewer resources (e.g., computational resources, time, energy) that may be needed in order to build the pallet to fulfill the pick order request.

The aisle pick item list generator 704 can be configured to generate aisle-based lists, as described herein (e.g., refer to blocks 406-410 in FIG. 4A). Each aisle-based list can include candidate items located within that aisle that can fulfill the pick order request. Moreover, the aisle pick list generator 704 can include an aisle sorting engine 712. The aisle sorting engine 712 can be configured to sort items in the aisle-based list based on their location from a front to a back of the warehouse.

The item maximum weight load determiner 706 can be configured to infer how much weight a layer of a particular item can support without being damaged or otherwise crushed, as described in reference to the process 600 in FIG. 6. The determiner 706 can determine a maximum load for an item when the item is requested in the pick order request. The determiner 706 can also determine the maximum load at a time before the pick order request is received, for example, when the item is delivered to the warehouse by a supplier.

The pallet build engine 708 can be configured to determine, for each aisle-based list, one or more pallets to build to fulfill the pick order request (e.g., refer to blocks 412-434 in FIGS. 4A-D). The engine 708 can use the techniques described throughout this disclosure to determine optimal pallet builds. To determine the pallet builds, the engine 708 can also include a weight threshold determiner 714, a height threshold determiner 716, a layer sequencing engine 718, and an aisle pick item list updater 720.

The weight threshold determiner 714 can be configured to determine how much weight each layer of items can support if placed as a bottom layer on a pallet (e.g., refer to blocks 308-316 in FIG. 3A; blocks 418-420 in FIG. 4B). The determiner 714 can also identify which layers of items can be stacked on top of each other without causing items on lower layers to be damaged or otherwise crushed.

The height threshold determiner 716 can be configured to determine how many and which layers can be stacked on the pallet without exceeding a predefined maximum height for the pallet (e.g., refer to block 422 in FIG. 4B). In some implementations, the determiner 716 can also make a determination of whether additional pallets need to be built in order to stack any remaining pallets that would have otherwise caused the first pallet to exceed the maximum height.

The layer sequencing engine 718 can be configured to generate and/or update a pick sequence/order per pallet (e.g., refer to blocks 314-316 in FIG. 3A; refer to pallet pick orders 322A-E, 324A in FIG. 3B; refer to blocks 420 and 424 in FIGS. 4B-C; refer to pallet pick orders 524A-B in FIG. 5C). As described throughout this disclosure, the pick sequence can list the items from back to front of the warehouse, where the items from the back of the warehouse are to be picked up first and the items from the front of the warehouse are to be picked up last. As described herein, the pick order can be a reverse of an evaluation order (e.g., refer to evaluation order 118 and pick order 120 in FIG. 1).

The aisle pick item list updater 720 can be configured to update the aisle pick item list whenever an item is removed from the list and added to the layer sequencing for the pallet build (e.g., refer to blocks 314-316 in FIG. 3A; refer to candidate item lists 320A-E in FIG. 3B; refer to block 426 in FIG. 4C; refer to candidate item lists 522A-C in FIG. 5C).

Moreover, the pallet build output generator 710 can be configured to generate output that instructs a warehouse worker or warehouse vehicle an order by which to pick the items and build the pallet(s) (e.g., refer to blocks 436 and 440 in FIG. 4D). The generator 710 can also collect additional information that can be used to assist the warehouse worker or warehouse vehicle in building the pallet(s), as described throughout this disclosure.

The computer system 110 also includes an arrangement model engine 760. In some examples, the arrangement model engine 760 is configured to interdependently coordinate the build instructions by executing a mathematical arrangement model, such as a mixed-integer program, across the entire facility environment. This centralized orchestration allows the computer system 110 to solve for a global optimization of facility tasks by processing high-dimensional data from the warehouse information 722. Specifically, the arrangement model engine 760 can access and analyze item information 724A-N, which includes an identifier 730, size 732, weight 734, maximum weight load 736, and product description 738 for each SKU. Simultaneously, the engine 760 processes pallet build information 728A-N, which contains aisle lists 726A-N, pick order identifiers 740, item identifiers 730A-N, height thresholds 744, weight thresholds 746, layer sequences 748, and customer identifiers 750. The engine 760 acts as a centralized brain for the facility, evaluating thousands of possible permutations of picking and replenishment sequences to determine the most energy-efficient and time-sensitive workflow. By modeling the warehouse as a comprehensive system of overlapping constraints, the arrangement model engine 760 can identify synergies between independent pick orders that would be invisible to localized planning modules.

By centralizing the decision-making process, the arrangement model engine 760 can resolve technical problems related to resource contention that arise in complex logistics environments. For example, the engine 760 can manage the traversal of multiple vehicles attempting to access the same storage location 742 or ground-level pick zone simultaneously, implementing timing offsets or route adjustments to prevent traffic congestion. In some implementations, the arrangement model engine 760 is configured to solve for these variables over a predetermined maximum amount of time, returning the best-found solution upon expiration of the timer. This ensures that the system 110 maintains a consistent operational cadence even when encountering highly complex optimization problems that might otherwise lead to computational latency. This time-limited approach is particularly valuable in high-volume facilities where operational continuity is more critical than a theoretically perfect solution that arrives too late to be actionable. The engine 760 can dynamically adjust this processing window based on current facility throughput requirements, ensuring that the orchestration plan is always delivered within the latency threshold needed to keep vehicles and workers in motion.

In some implementations, the arrangement model engine 760 works in close coordination with the pallet build engine 708 and its various sub-components to ensure that all determined sequences adhere to strict structural and temporal constraints. For instance, the arrangement model engine 760 can utilize the weight threshold determiner 714 and the height threshold determiner 716 to verify that the vertical arrangement of items on a destination pallet will not exceed physical limits or compromise the integrity of bottom-layer cases. The engine 760 can further utilize a layer sequencing engine 718 to identify “scoop and go” opportunities, where full layers of items can be moved as a single unit to serve as a stable base layer. By solving for the facility-wide plan as a unified optimization problem, the arrangement model engine 760 can identify opportunities to convert inefficient cherry picks from elevated storage locations into high-efficiency partial picks in the ground-level pick zones. This conversion reduces the cumulative electrical power consumption of lift motors and reduces the mechanical wear on traction components by minimizing unnecessary travel and high-reach maneuvers. This transformation of picking strategies is not merely a task re-ordering but a fundamental improvement in the mechanical duty cycle of the facility equipment, as it replaces energy-intensive vertical lifts with simplified horizontal retrievals from high-access zones.

Furthermore, the arrangement model engine 760 can interact with an external warehouse management system 700 via one or more networks 112 to receive updated pick order requests and provide real-time status updates on pallet build operations. Through an aisle pick item list updater 720, the engine 760 can dynamically refresh the active task queue in response to detected environmental changes, such as the early arrival of a transport vehicle or a reported execution failure. This iterative re-optimization allows the system 110 to maintain high space utilization and facility throughput, effectively reducing the overall physical footprint required to fulfill a given volume of orders. By maximizing operational density, the system can reduce the energy required for heating, cooling, and illuminating the facility, while the transmission of targeted delta updates via the network 112 helps preserve the battery life of mobile computing devices by reducing context-switching and I/O overhead. Because the engine 760 only transmits the specific modifications required to update a task list, rather than re-sending the entire facility plan, the mobile devices can remain in low-power sleep states for longer durations. This reduction in network traffic and processing cycles ensures that the communication infrastructure remains responsive to safety-critical alerts while simultaneously lowering the total cost of ownership for the handheld hardware used by facility staff.

The warehouse information data store 722 can store item information 724A-N, aisle-based lists 726A-N, and pallet build information 728A-N. The item information 724A-N can include, for each item, an identifier 730, a size 732, a weight 734, a maximum weight load 736, and a product 738 (e.g., refer to the item information 318 in FIG. 3B). The identifier 730 can be a SKU, barcode, label, QR code, or another identifier, as described throughout this disclosure. The size 732, weight 734, and the maximum weight load 736 can be determined by one or more components of the computer system 110, as described herein. When the computer system 110 makes such determinations, the computer system 110 can store the determinations for the associated item in the warehouse information data store 722. Moreover, the product 738 can identify a type of the item.

The aisle-based item list 726A-N can include information associated with each of the aisle-based lists that are generated by components of the computer system 110. For example, for each of the lists 726A-N, a pick order identifier 740, pick item identifiers 730A-N, and storage location 742 can be identified and stored. The lists 726A-N can therefore include associations between different items 724A-N that can be selected to build pallets for each of the aisles with each aisle. The lists 726A-N can also associate the items in the aisle with the pick order request using the identifier 740. The lists 726A-N can also include the storage location 742, which can indicate where the aisle is located within the warehouse.

Finally, the pallet build information 728A-N can be generated for each pallet that can be built to fulfill the pick order request. For each pallet build 728A-N, the aisle list 726A-N, pick order identifier 740, item identifiers 730A-N, height threshold 744, weight threshold 746, layer sequence 748, and customer identifier 750 can be stored. The pallet build information 728A-N can provide associations with the item information 724A-N and the aisle-based item lists 726A-N. The height threshold 744 can indicate a maximum height of the pallet. The height threshold 744 can also indicate a current height of the pallet based on the layer sequence 748. The weight threshold 746 can indicate how much weight each layer can support. The weight threshold 746 can also indicate how much weight is currently on the pallet. Moreover, components of the computer system 110 can use the pallet build information 728A-N to generate output about how to build the pallets to fulfill the pick order request.

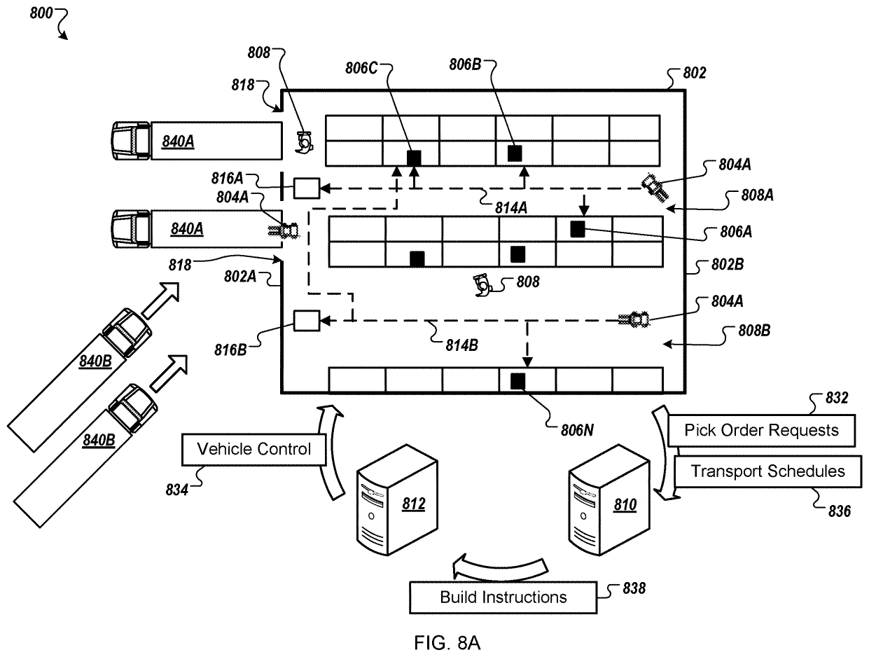

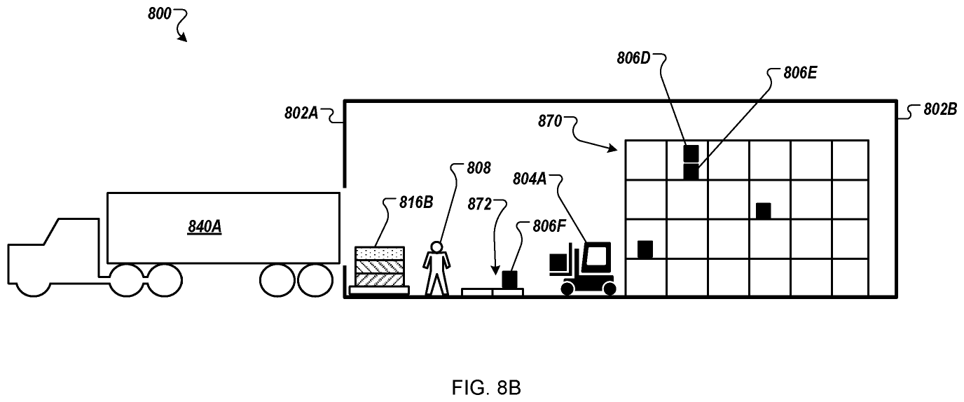

FIG. 8A is a conceptual diagram of a system 800 for determining pick pallet build operations and orchestrating dynamic, facility-wide logistics in a warehouse environment. In some embodiments, the system 800 can be the system 100, and items included in the system 800 can correspond to similarly numbered items in the system 100. For example, a facility 802 of FIG. 8A can be the environment 102 of FIG. 1, and a pallet item 806A in FIG. 8A can be the pallet item 106A of FIG. 1.

The system 800 can include a computer system 810, which can be configured to execute a facility-wide orchestration engine that concurrently processes a set of outbound transport vehicles, such as vehicles 840A (e.g., manual or automatic forklifts, autonomous vehicles) currently docked at doors 818, alongside scheduled vehicles 840B. In some implementations, this facility-wide optimization can utilize a mixed-integer programming solver to evaluate shared facility resources, such as ground-level pick zones, across the entire facility 802 rather than planning for each load in isolation. The computer system 810 can receive one or more pick order requests 832 and one or more transport schedules 836 from an external system, such as a warehouse management system or a transport management system. Based on the pick order requests 832, the transport schedules 836, and the identified facility state, the computer system 810 can generate a collection of build instructions 838.

As illustrated in FIG. 8A, the system 800 can manage the construction and staging of outbound pallets, such as a first pallet 816A and a second pallet 816B. In some examples, the first pallet 816A can represent a case-pick pallet being staged for loading into a first transport vehicle 840A, while the second pallet 816B can represent a pallet being constructed or staged for another transport vehicle. The computer system 810 can transmit the build instructions 838 to a computer system 812. The computer system 812 can be configured to use the build instructions 838 to determine and transmit a collection of vehicle control instructions 834 to one or more facility workers 808 and/or one or more facility vehicles 804A. By separating the high-level orchestration at the computer system 810 from the instruction determination and transmission at the computer system 812, the system 800 can maintain high-frequency task updates while reducing the processing load on any single computing node.

When building the pallets 816A-B, the vehicle 804A can move from a back 802B of the facility 802 to a front 802A of the facility 802. As a result, the pallets 816A-B can be complete, and their heaviest, once at the front 802A of the facility 802, making it easier and less energy or time consuming to move the pallets 816A-B to a docking area or outbound transport vehicles (e.g., trucks, shipping containers). The vehicle 804A can travel along route 814A to pick the items 806A, 806C, and 806B in order.

As shown in this example, only 40 of the requested 50 of item 806B can be picked for the pallet 816A. This can occur because the computer system 810 may determine that the pallet 816A (e.g., as built using the pick sequence 124A) satisfies a pallet height threshold. The pallet height threshold can be 60 inches. Once the pallet height threshold is satisfied, additional items may not be added to the pallet 816A because then the pallet 816A would be too tall. If the pallet 816A exceeds the pallet height threshold, then the pallet may not be structurally sound. Thus, additional items that may still need to be picked can be sequenced for another pallet build (e.g., such as the pallet 1 24B).

In the example of FIG. 8A, a pick sequence is determined by the computer system 810 for the pallet 816B. This pick sequence indicates that the vehicle 804A can travel along route 814B in aisle 808B to pick up 60 of item 806N, which is closer to the back 802B of the warehouse 802 than the front 802A. The vehicle 804A can then pick up the remaining quantity of item 806B from the aisle 808A, which is at the front 802A of the warehouse 802. Here, the pallet 816B can be built using partial layers, in which the top layer may not be a full layer of the items 806B and the top layer can include a quantity of leftover items 806B that could not fit into the pick sequence for the pallet 816A. Moreover, as described in reference to determining the pick sequence for the pallet 816A, the computer system 810 can determine that the item 806N can support the weight of the item 806B and therefore the item 806N can be placed as a bottom layer of the pallet 816B.

The build instructions 838 can include the coordinated sequences of replenishment and pick tasks, along with structural information such as where each individual case should be placed to ensure pallet stability. For instance, the build instructions 838 can specify that a base layer of items 806F be picked first, followed by specific cases of items 806D to be placed directly or indirectly on top. By transmitting these build instructions 838 as part of the vehicle control instructions 834, the system 800 can synchronize the activities of multiple workers 808 and vehicles 804A to ensure that the set of pick order requests 832 is fulfilled efficiently.

By orchestrating multiple trips concurrently, the computer system 810 can identify opportunities to convert inefficient cherry picks into partial picks. As used herein, a cherry pick may refer to a manual or semi-manual pick operation where a facility worker 808 retrieves a specific case or quantity of items from a source pallet located in a general storage area of the facility 802. In some examples, a cherry pick can involve using high-reach material handling equipment to retrieve a source pallet from an elevated storage location to perform the pick, after which the source pallet is returned to the elevated storage location.

This conversion to partial picks can be achieved by analyzing the collective demand of multiple active and pending pick order requests 832 to determine which source pallets can be positioned within high-access pick zones to serve an increased number of transport vehicles 840A, 840B. This analysis can facilitate the positioning of source pallets to improve the efficiency of traversal paths by reducing the total distance traveled by facility vehicles 804A to fulfill the set of pick order requests 832 and construct the outbound pallets 816A, 816B.

In some examples, the computer system 810 can operate on a periodic, continuous, and/or event-driven polling and tuning loop. For instance, a periodic polling process may involve the computer system 810 re-evaluating the facility state at a regular, configurable time interval, such as every five minutes, to ensure that picking and replenishment tasks remain aligned with the current inventory distribution. In some implementations, an event-driven loop can be triggered by specific changes in the environment of the facility 802, such as the arrival of a transport vehicle 840A at a loading door 818, the reporting of a pallet build execution failure, and/or the receipt of updated pick order requests 832.

During these iterations, the computer system 810 can identify whether changes in the facility 802, such as the arrival of a new truck 840B or an update to a transport schedule 836, permit an improved build sequence for the pallets 816A, 816B. If an alternative solution is identified, the system 800 can automatically cancel all or part of an existing unreleased plan and re-create a new, updated plan that aligns with the real-time facility state.

The computer system 810 can also incorporate failure resilience logic to handle execution exceptions automatically. If a pallet build failure is detected, such as when a source pallet cannot deliver the expected quantity of cases for pallet 816A, the system 810 can dynamically adjust other active pallet plans to make up the difference without requiring manual inventory control intervention. This automated resolution of build failures can improve the operational stability of the system 800 by reducing the frequency of system-level alerts and reducing the need for external data entry from inventory control personnel.

In some implementations, the computer system 810 can integrate the functional logic of picking and replenishment into a unified algorithm. This interdependent decision-making process can link outbound pick sequencing directly to replenishment tasks. The system 810 can execute a replenishment orchestration module to determine the build sequence while simultaneously coordinating the timing for moving source pallets into a ground-level pick zone to enable improved partial picking.

For manual and hybrid warehouse environments, the computer system 810 can manage a series of plan states to account for variable execution speeds or human factors. New plans may be generated in an unreleased state, during which they can be maintained as immutable until the system 800 is ready to commit them to the execution queue.

Once a plan is transitioned to a released state, it can be assigned to a facility worker 808 and/or an automated vehicle 804A. In some examples, once work has commenced on a specific plan, the computer system 810 can transition the plan to a locked state, which prevents the optimization engine from canceling or modifying the plan during a subsequent re-evaluation.

The computer system 810 can also differentiate between static and dynamic replenishment strategies. Certain locations can be assigned to products having higher demand frequencies to remain in the pick line, while other locations can be dynamically assigned to products having lower demand frequencies based on high-frequency evaluation of the set of pick order requests 832.

The implementation of this facility-wide orchestration can provide measurable improvements to the underlying computer and network systems. By solving for facility-wide efficiency through a centralized mathematical model, the system 800 can reduce the computational overhead and network traffic associated with resolving individual resource conflicts between isolated planning processes. In some examples, this centralized approach reduces memory contention and processing cycles by eliminating the need for redundant negotiation between independent load-planning nodes.

Furthermore, the continuous re-optimization can improve the utilization of facility hardware, such as vehicles 804A in the form of automated forklifts, by reducing idle time and optimizing traversal routes 114a, 114b based on a comprehensive view of facility-wide demand. This integrated approach can result in reduced energy consumption for facility vehicles and improved throughput for the loading doors 818.

FIG. 8B is a conceptual side view diagram of the example facility 802. In some implementations, the facility 802 can be organized into different storage and picking zones based on the accessibility of items and the specific material handling equipment used to reach them. As illustrated, the facility 802 can include a ground level pick zone 872 and one or more elevated storage locations 870. This vertical and horizontal segmentation allows the system 800 to optimize the physical movement of workers and vehicles while ensuring that the set of frequently requested items are positioned for rapid retrieval.

The ground level pick zone 872 can be configured to store source items that are used for partial pick operations, such as a source item 806F. In some examples, the ground level pick zone 872 may consist of level 1 storage locations that are directly accessible by a facility worker 808 using a manual or semi-manual vehicle, such as a pallet jack. The traversal path through this zone may be configured in a specific geometric pattern, such as a U-shape where pickers collect items from one side of an aisle before turning back on the other, or a Z-shape where pickers collect from both sides of an aisle simultaneously. Because ground level space may be limited within the facility 802, the computer system 810 can be configured to strategically manage which products are positioned within the ground level pick zone 872 at any given time. For instance, products having higher demand frequencies, such as “fast moving” consumer goods, can be assigned to static locations within the pick zone 872. Conversely, products having lower demand frequencies may be dynamically assigned to open spots in the pick zone 872 based on a high frequency evaluation of active pick order requests 832.

The elevated storage locations 870 can be positioned above the ground level pick zone 872 or in separate racking areas of the facility 802. These storage locations 870 are typically used for long term storage or for products with lower pick frequencies that do not justify a permanent spot on the pick line. As shown in the side view of FIG. 8B, the elevated storage locations 870 can contain vertically stacked items, such as a first item 806D positioned directly on top of a second item 806E. To access items in the elevated storage locations 870, a facility worker 808 may utilize high reach material handling equipment, such as a high reach operator vehicle 804A. The use of such equipment often requires more time and space for maneuvering compared to the manual tools used in the ground level pick zone 872, including the mechanical overhead of elevating forks, aligning with specific rack levels, and lowering source pallets to a pick height.

In some implementations, the system 800 can differentiate between partial picks and cherry picks based on the location of the source material. A partial pick can occur when a facility worker 808 moves a case directly from a source item 806F in the ground level pick zone 872 to a destination pallet 816B. Conversely, a cherry pick may occur when a facility worker 808 retrieves a case from a source item, such as item 806D, located in an elevated storage location 870. This process may involve the high reach operator vehicle 804A taking the source item down from the racking, performing the manual pick of the required cases, and then returning the source item to its storage location.

The computer system 810 can interdependently manage outbound picking and replenishment tasks. For example, if the system 810 determines that upcoming pick order requests 832 require a significant quantity of an item stored in an elevated storage location 870, it may generate a replenishment task to move a source item into an open spot within the ground level pick zone 872. Because the pick zone 872 has limited capacity, the system 810 may implement a throttling mechanism, evaluating replenishments for all open pallet plans and releasing them only when sufficient capacity is identified in the pick line. By converting potential cherry picks into partial picks, the system 800 can reduce the cumulative labor cost and energy associated with operating high reach equipment (e.g., vehicles 804A).

Furthermore, the side view perspective of FIG. 8B illustrates how the computer system 810 can account for the vertical state of the warehouse. In some examples, the system 810 can track the stack position and height of items, such as the relationship between item 806D and item 806E, to ensure that replenishment tasks are sequenced correctly. This vertical visibility can prevent computational errors that might occur if the system attempted to move a base item, such as item 806E, while it was still supporting another item, such as item 806D.

By managing the pick line and storage locations as a unified system, the computer system 810 can improve the utilization of facility space. In some implementations, this integrated management reduces the number of database I/O operations and network polling requests by consolidating the logic for picking and replenishment into a single orchestration cycle. This consolidation ensures that task assignments are based on the most current warehouse state, which may lead to improved battery life for facility vehicles 804A and reduced network congestion.

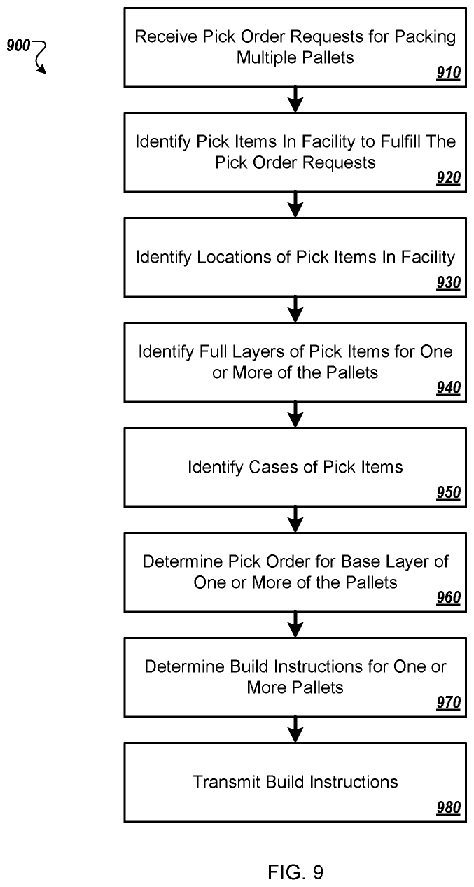

FIG. 9 is a flowchart of a process 900 for determining pick sequences and orchestrating pallet build operations across a facility. In some implementations, the process 900 can be performed by the computer system 810 to dynamically optimize pallet build sequences based on real-time facility states and transport schedules.

At 910, a collection of pick order requests for packing multiple pallets can be received. For example, the computer systems 810 and/or 812 can receive a series of pick order requests 832 as shown in FIG. 8A. The set of pick order requests can include multiple lists of items to be packed onto multiple pallets to fulfill customer orders. In some implementations, the set of pick order requests can be based on a collection of outbound transport vehicles, such as the transport vehicles 840A currently docked at doors 818 or transport vehicles 840B scheduled to arrive at the facility within a predetermined period of time.

At 920, pick items in the facility to fulfill the pick order requests can be identified. For example, as illustrated in FIG. 8B, the computer system 810 and/or 812 may identify candidate items such as item 806F in the ground level pick zone 872 and items 806D and 806E in the elevated storage locations 870 as potential sources for the requests. This identification process may involve querying a warehouse management system to locate inventory that matches the SKU, quantity, quality requirements, owner codes, and batch numbers of the order lines across the entire facility to enable global optimization rather than planning for a single trip in isolation.

At 930, locations of pick items in the facility can be identified. For example, the computers 810 and/or 812 can determine where the items 806A, 806N are within the facility 802, such as which aisle 808A or 808B, which rack, or which specific storage level. In some implementations, the computer system 810 tracks whether an item is located at a first level for manual retrieval or at an upper level requiring a vehicle 804A configured as high reach material handling equipment, which introduces different mechanical and temporal constraints on the building sequence.

At 940, full layers of pick items for one or more of the pallets can be identified. For example, as used herein, a full layer may represent a tier of items that can be moved as a single unit from a source pallet to a destination pallet. In one example referring to FIG. 8B, the system 810 may identify that a set of items 806F required for destination pallet 816B constitutes a full layer. In some implementations, the computer system identifies that at least one of the full layers is to include a base layer for one or more of the pallets to facilitate an improved scoop and go pick operation.

At 950, cases of pick items can be identified. For example, this can involve identifying individual boxes or containers that are to be picked from source pallets to fulfill order lines that require less than a full layer or full pallet. Referring to FIG. 8B, the computer system 810 may identify cases to be picked from item 806D in the elevated storage location 870 for placement on destination pallet 816B.

At 960, a pick order for a base layer of one or more of the pallets can be determined. For example, the computer system 810 and/or 812 can determine an order for picking the cases of the candidate pick items to be packed on top of the one or more full layers that include the base layer for one or more pallets of the multiple pallets. Referring to the vertical arrangement in FIG. 8B, the system 810 may determine that cases of item 806D are to be packed on top of the full base layer 806F on destination pallet 816B.

In some implementations, this determination can be based on structural information for the identified cases of the candidate pick items, such as a maximum weight load that each case can support without being crushed. The maximum weight load for each identified case can be determined by identifying a number of layers (N) on a source pallet and a weight (W) for each layer. A load (BL) on a layer of the source pallet (e.g., the bottom layer) can then be determined by multiplying the weight for a layer by one less than the number of layers on the source pallet (e.g., BL=(N−1)*W). The maximum weight load can then be determined based on applying a margin threshold (e.g., a multiplier such as 1.2) to that load (e.g., Maximum Weight Load=BL*1.2). This calculation can allow the system to infer the strength of the items based on the physical load they successfully supported during transit to the facility. As a practical example, if a source pallet for a specific SKU is received from a supplier with 6 layers and each layer weighs 150 lbs, the computer system 810 can identify the supplier-provided load on the bottom layer as 750 lbs (150*(6−1)). By applying a margin threshold multiplier of 1.2, the computer system 810 can calculate a maximum weight load of 900 lbs. During the determination of the pick order, the computer system 810 can use this 900 lb limit to facilitate that the cumulative weight of all cases positioned directly or indirectly on top of that SKU does not exceed the inferred structural capacity.

At 970, build instructions for one or more pallets can be determined. For example, the computer system 810 and/or 812 can generate a comprehensive build plan based on item data corresponding to each of the identified cases. This determination may involve executing a mixed integer program to interdependently coordinate replenishment tasks, such as moving item 806E to the pick zone 872, with outbound pick tasks. In some implementations, the mathematical model of the mixed integer program can resolve technical problems associated with resource contention and synchronization between picking and replenishment hardware within shared pick zones. This centralized orchestration improves hardware utilization by reducing memory contention and processing cycles that would otherwise be required for redundant negotiation between independent load-planning nodes.

At 980, build instructions can be transmitted. For example, the instructions can be transmitted as vehicle control signals 834 of FIG. 8A to a computing device to route a facility worker 808 or an automated vehicle 804A to pick the cases according to the generated sequence. In some implementations, the build instructions may include specific traversal paths, such as U-shape or Z-shape routes, to reduce the total distance traveled by facility vehicles. In some examples, the computer system 810 may periodically, continually, or in response to detected events, re-evaluate at least a portion of the facility 802 to transmit updated instructions in response to an execution failure or inventory discrepancy. For instance, if the computer system 810 detects that a vehicle 840B has arrived early at a loading door 818 as shown in FIG. 8A, or that an item 806E in an elevated storage location 870 is currently inaccessible as shown in FIG. 8B, the system 810 can generate an updated plan. In some implementations, the updated plan also accounts for retrieval work that is already in progress, avoiding wasting effort, time, and energy that has already been invested in the task. Transmitting only the modifications, such as delta updates, reduces network traffic, reduces I/O overhead on mobile devices, and reduces memory usage by limiting the frequency of processing interrupts on the mobile computing devices.

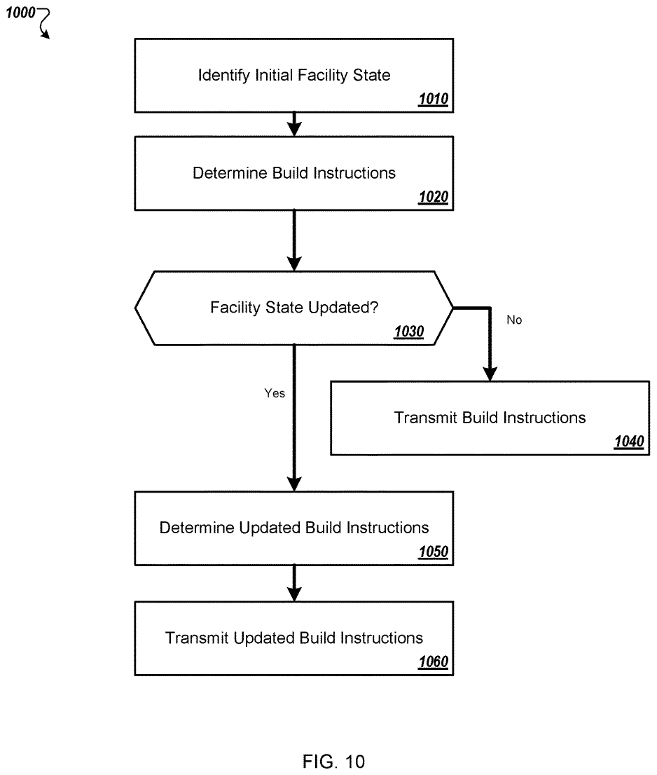

FIG. 10 is a flowchart of a process 1000 for dynamically determining and updating pallet build instructions based on real-time facility states. In some examples, the process 1000 can be performed by the computer system 810 and/or 812 to ensure that facility operations remain synchronized with environmental changes within the facility 802.

An initial facility state can be identified at 1010. For example, the computers 810 and/or 820 can involve identifying the presence and status of transport vehicles 840A, 840B at loading doors 818, the locations of items 806 and pallets 816 across picking and storage locations 870, 872, and the current activity of facility workers 808 as shown in FIG. 8A and FIG. 8B. In some examples, this initial identification can serve as a baseline snapshot that provides data for generating a facility-wide orchestration plan.

In some examples, the locations of the candidate pick items can distinguish between ground-level pick zone locations and elevated storage locations in the facility. For instance, the computer system 810 and/or 812 can identify that a first item 806F is positioned within a ground-level pick zone 872 for direct manual access by a facility worker 808, while a second item 806D is positioned within an elevated storage location 870 that requires the mechanical reach of a high-reach operator vehicle 804A to perform a pick.

Build instructions can be determined at 1020. For example, the computer system 810 and/or 812 can execute a construction model, such as a mixed-integer programming solver, to determine an efficient sequence for constructing outbound pallets 816A, 816B. This determination can involve identifying scoop and go opportunities for full layers of items 806F and determining a build order for individual cases of items 806D to be packed on top of the layers. By solving for global efficiency, the system 810 reduces the total distance traveled by facility vehicles 804A while ensuring the structural stability of each pallet.

At 1030, a determination can be made as to whether the facility state has been updated. For example, the computer system 810 and/or 812 can operate on a periodic, continuous, or event-driven polling and tuning loop to detect environmental changes. In some examples, environmental changes can refer to real-time deviations from the baseline facility snapshot, including logistical shifts, inventory exceptions, or updated order data. For instance, logistical shifts can involve the arrival or departure of transport vehicles 840A, 840B outside of a scheduled window, while inventory exceptions can include reported pallet build execution failures where a source item 806E is damaged or temporarily inaccessible.

In some implementations, the updated facility state can include a reported pallet build execution failure, and the computer system 810 and/or 812 can automatically resolve the reported pallet build execution failure by identifying one or more alternative storage coordinates for the required items, canceling at least a portion of the build instructions, and creating the updated build instructions without requiring manual inventory control intervention. For example, the system may detect the early arrival of a transport vehicle 840B, a reporting of an execution failure where a source item 806E is inaccessible, or a change to the pick order requests 832. If no update is detected, the process can proceed to block 1040.

At 1040, build instructions can be transmitted. For example, if the baseline facility state remains unchanged, the computer system 810 and/or 812 can transmit the instructions determined at block 1020 to mobile computing devices or automated vehicles 804A to commence the pallet build operations.

If a facility state update is detected at 1030, updated build instructions can be determined at 1050. For example, the computer system 810 and/or 812 can identify plans currently in progress based on execution feedback signals, such as item scan events or weight sensor updates from the destination pallets 816, to protect work already performed by facility workers 808. For instance, the system may identify plans in a locked state where a worker has already begun picking items 806F, and plans in a released state that are assigned but not yet started. The system 810 can maintain the locked plans as immutable by treating the already-picked items as fixed physical constraints while re-solving the orchestration model for the unreleased or unlocked portions of the facility-wide plan. This re-optimization can account for the new environmental variables while avoiding the waste of effort, time, and/or energy previously invested in active tasks.

At 1060, updated build instructions can be transmitted. For example, the computer system 810 and/or 812 can generate and transmit delta updates that include only the modifications required to transition from the previous plan to the updated plan. For example, if a new truck arrival permits a more efficient replenishment move, the system 810 can transmit the updated task sequence to the relevant vehicle 804A.

In some implementations, by transmitting only the modifications as delta updates, the computer system 810 and/or 812 can minimize the frequency of processing interrupts and context switching on the CPUs of the mobile computing devices. In some examples, this targeted transmission can reduce network congestion and reduce I/O buffer overhead on the mobile devices, thereby improving the battery life of the devices and the overall reliability of the communication network within the facility 802. Furthermore, this dynamic update process improves the operational stability of the facility 802 by automatically resolving inventory discrepancies or schedule changes without requiring manual intervention from inventory control personnel.

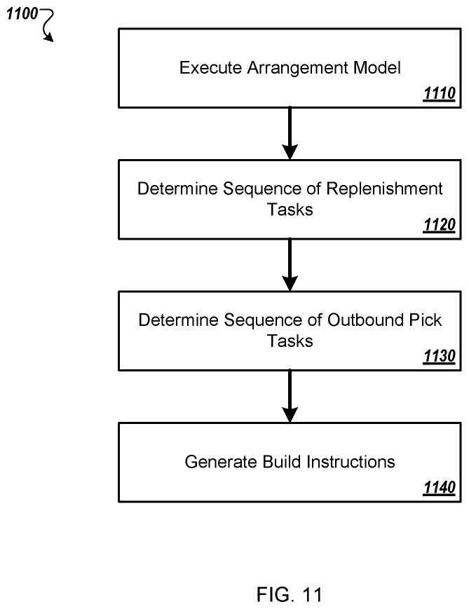

FIG. 11 is a flowchart of a process for determining a pick zone replenishment by determining build instructions by interdependently coordinating replenishment and outbound pick tasks. In some examples, the process 1100 can be performed by the computer system 810 and/or 820 to optimize the arrangement of items across multiple destination pallets while accounting for facility-wide resource constraints.

At 1110, an arrangement model configured to generate build instructions can be executed. For example, the computer system 810 and/or 820 can execute a mathematical arrangement model, such as a mixed integer program, to solve for a global optimization of tasks across the facility 802. In some examples, this execution can involve processing the initial facility state identified at 1010, including the locations of items 806, the status of transport vehicles 840A, 840B, and/or the availability of material handling equipment 804. By executing a centralized arrangement model, the system 810 and/or 820 can resolve technical problems associated with resource contention, such as multiple vehicles 840A attempting to access the same elevated storage location 870 or the same ground level pick zone 872 simultaneously.

In some examples, executing the arrangement model can include processing a mixed integer program for a predetermined maximum amount of time. For instance, the computer system 810 and/or 820 can be configured to return a best-found solution for the build instructions after repeatedly attempting to find multiple different possible solutions for a preset amount of time (e.g., 5 seconds, 15 seconds, 60 seconds, 5 minutes, 10 minutes), and providing the best solution from among the finite number of solutions that could be searched in the provided amount of time, even if that solution is not fully or perfectly optimized. This time-limited execution can ensure that the system 800 provides actionable instructions within a window that aligns with the operational pace of the facility 802, even if a mathematically optimal solution has not yet been reached. This approach prevents computational bottlenecks and ensures consistent system responsiveness during periods of high facility activity, such as instances where the processing time for a global optimum exceeds a latency threshold required for continuous facility throughput (e.g., sometimes having a timely but imperfect solution can be better than a delayed solution or waiting with no solution at all).

At 1120, a sequence of replenishment tasks for moving source pallets from the elevated storage locations into the ground-level pick zone locations can be determined. For example, the computer system 810 and/or 820 can identify that one or more items 806D, 806E stored in elevated storage locations 870 need to be moved to ground level pick zones 872 to fulfill upcoming pick order requests 832. In some examples, the sequence of replenishment tasks is determined based on the expected arrival times of transport vehicles 840B at the loading doors 818. By determining the replenishment sequence as part of a unified arrangement model, the system 810 and/or 820 can ensure that high-retrieval-frequency items are positioned in accessible zones before a manual picking operation commences, which reduces the total retrieval time and energy consumption of high reach operator vehicles 804A.

At 1130, a sequence of outbound pick tasks to fulfill the collection of pick order requests can be determined, where the outbound pick tasks include partial picks from the ground-level pick zone locations and individual case picks from the elevated storage locations. For example, the computer system 810 and/or 820 can determine an order for picking cases from source items 806F or replenished items to be packed onto destination pallets 816. In some examples, the sequence of outbound pick tasks is determined interdependently with the sequence of replenishment tasks. This interdependency ensures that the pick tasks are only scheduled for execution after the required items have been successfully replenished to the pick zone 872. Furthermore, the computer system 810 and/or 820 can determine the pick sequence based on structural information for the items, such as weight, dimensions, and fragility, to ensure that heavier items are picked earlier in the sequence to serve as a stable base for the destination pallet 816B.

At 1140, build instructions can be generated. For example, the computer system 810 and/or 820 can compile the coordinated sequences of replenishment and pick tasks into a single set of actionable instructions for the facility. These build instructions can include specific route guidance, such as U-shape or Z-shape traversal paths, and timing offsets to prevent traffic congestion within the facility aisles 808A, 808B. In some examples, the generation of these instructions accounts for the current state of work already in progress to avoid redundant effort.

By interdependently determining replenishment and pick sequences through a unified arrangement model, the computer system 810 and/or 820 can improve the operational throughput of the facility 802 and the efficiency of space utilization within the facility 802. In some examples, this centralized orchestration reduces the volume of network control signals 834 and database I/O operations that would otherwise be required if replenishment and picking were managed by separate, uncoordinated systems. Furthermore, by improving throughput and space efficiency, the overall size and footprint of the facility 802 can be reduced relative to conventional facilities. In some examples, this relative reduction in square or cubic footage can reduce the amount of energy needed to heat, cool, and illuminate the facility 802, and can reduce the total distances that are travelled within the facility 802, which can improve the overall energy efficiency and environmental impact of the facility 802. Consequently, this process can improve the battery life of mobile computing devices and reduce the cumulative mechanical wear and electrical power consumption of the facility vehicles 804A by minimizing the duty cycles of traction and lift motors.

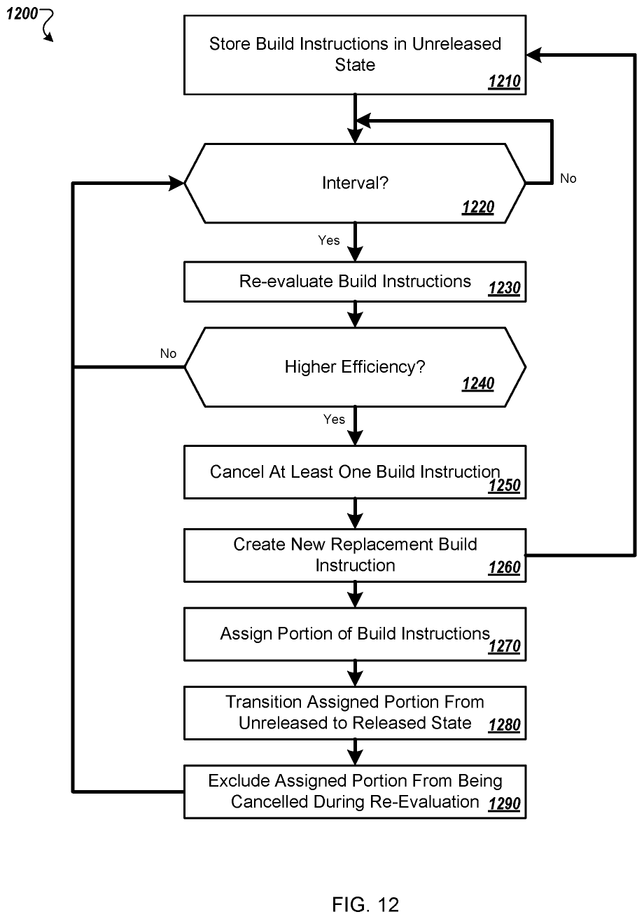

FIG. 12 is a flowchart of a process for determining a partial updated pick sequence for an aisle pallet. In some examples, the process 1200 can be performed by the computer system 810 and/or 820 to ensure that uncommitted tasks remain flexible in response to real-time changes within the facility 802.

At 1210, build instructions can be stored in an unreleased state. For example, the computer system 810 and/or 820 can generate an initial orchestration plan for constructing pallets 816A, 816B and store the corresponding tasks in an indexed instruction buffer in system memory. Within this buffer, each task can be associated with a status bit or boolean flag indicating the unreleased state, which allows for rapid status checks during high frequency polling cycles. In some examples, while in the unreleased state, the build instructions are not yet visible to or actionable by facility workers 808 or automated vehicles 804A. This allows the computer system 810 and/or 820 to maintain the build instructions as a flexible set of pending operations that can be modified without disrupting ongoing physical work.

At 1220, a determination can be made as to whether a configured time interval has elapsed. For example, the computer system 810 and/or 820 can operate on a periodic polling loop, such as every 30 seconds or every 5 minutes, to trigger a re-evaluation of the warehouse state. If the interval has not yet elapsed, the system can continue to wait. If the interval has elapsed, the process proceeds to block 1230.

At 1230, build instructions can be re-evaluated. For example, the computer system 810 and/or 820 can re-evaluate the build instructions held in the unreleased state against an updated facility state. This updated facility state can include new information regarding the arrival of transport vehicles 840B, changes in the availability of items 806 in the ground level pick zones 872, or updated priorities from a warehouse management system.

At 1240, a determination can be made as to whether a modified sequence yields a higher efficiency score. For example, the computer system 810 and/or 820 can execute the arrangement model to calculate a composite efficiency score based on weighted parameters including total travel distance, energy consumed by vehicle traction motors, and destination pallet stability indices. If a modified sequence of outbound pick tasks and replenishment tasks yields an improved score relative to the score of the current instructions, the system can designate the sequence for update. In some examples, determining the modified sequence includes identifying one or more other full layers of items 806F to form the base layer for one or more pallets 816 and iteratively determining another order for picking cases of items 806D to be packed on top of those layers. If no higher efficiency is identified, the process can return to the interval polling at block 1220.

At 1250, at least one build instruction can be canceled. For example, in response to determining that a higher efficiency score is achievable, the computer system 810 and/or 820 can cancel at least one of the build instructions currently held in the unreleased state. This cancellation can occur if the system identifies that a different source pallet or a different picking sequence would better serve the current set of transport vehicles 840A, 840B. However, in some examples, the computer system 810 and/or 820 may determine to retain certain unreleased instructions, for example, if they are already part of a sequence that remains optimal or if canceling them would create a temporal conflict with tasks that are already in a released or locked state. For instance, the computer system 810 and/or 820 can traverse a dependency tree for the build instructions to ensure that a cancellation event does not invalidate a prerequisite task. If an unreleased instruction is for a replenishment move required by a pick task that has already entered a locked state, the system can preserve that specific replenishment instruction to maintain the structural and temporal integrity of the orchestration plan.

At 1260, one or more new replacement build instructions can be created. For example, the computer system 810 and/or 820 can create a new build instruction to fulfill the requirement of the canceled instruction while aligning with the more efficient sequence identified during re-evaluation.

At 1270, a portion of the build instructions can be assigned. For example, the computer system 810 and/or 820 can select a subset of the instructions for execution and generate an I/O signal to transmit the corresponding control packets to a facility worker 808 or an automated vehicle 804A. This assignment effectively moves the tasks from a planning stage to an execution stage and triggers the generation of user interface updates on the receiving computing devices.

At 1280, the assigned portion can be transitioned from the unreleased state to a released state. For example, the computer system 810 and/or 820 can update the state metadata for the assigned instructions to indicate they are now active. In some examples, this transition can also be referred to as moving the instructions into a locked state.

At 1290, the assigned portion can be excluded from being canceled during re-evaluation. For example, the computer system 810 and/or 820 can treat the instructions in the released or locked state as substantially immutable constraints. By excluding these tasks from being canceled during the reevaluating loop, the system 810 and/or 820 protects work that is already in progress. This exclusion logic prevents race conditions between the re-optimization model and the physical execution layer, thereby ensuring that the effort and energy invested by workers 808 and vehicles 804A are not wasted by sudden plan modifications and reducing the frequency of processing interrupts on mobile devices.

By implementing this iterative polling and state management loop, the computer system 810 and/or 820 can continuously improve or optimize facility logistics without causing operational instability. In some examples, this process can reduce the cumulative idle time of transport vehicles 840A at loading doors 818 and reduce the overall energy consumption of the facility 802 by maintaining the most efficient pick sequences possible given the current environmental conditions. Furthermore, by improving the throughput of the facility and the efficiency of space utilization within the facility 802, the overall size and footprint of the facility 802 can be reduced while still fulfilling the same volume of pick order requests 832. This relative reduction in square or cubic footage can reduce the amount of energy needed to heat, cool, and illuminate the facility 802. Additionally, increasing the operational density of the warehouse floor through dynamic state re-evaluation can reduce the total distances that have to be travelled within the facility 802, thereby improving the overall energy efficiency and environmental impact of the facility 802.

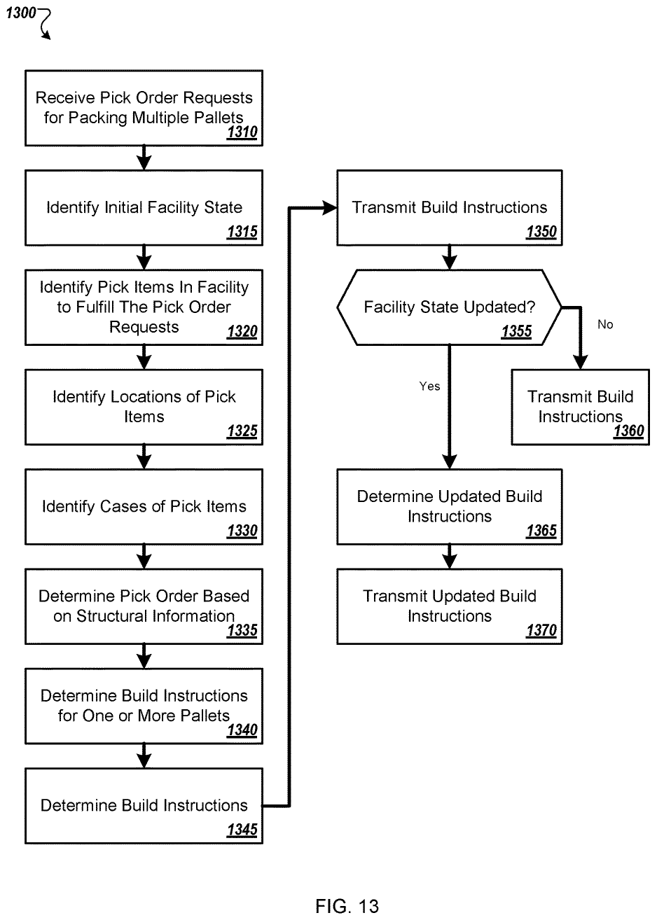

FIG. 13 is a flowchart of another process for determining a pick sequence for an aisle pallet and dynamically updating instructions based on facility state re-evaluations. In some examples, the process 1300 can be performed by the computer system 810 and/or 820 to maintain high operational throughput, optimize space utilization, and improve energy efficiency within the facility 802. By centralizing the orchestration of both replenishment and outbound picking, the process 1300 resolves technical challenges related to resource contention, mechanical synchronization across shared warehouse zones, and the computational latency associated with large-scale logistics planning.

At 1310, a collection of pick order requests for packing multiple pallets can be received. For example, the computer system 810 and/or 820 can receive a set of pick order requests from an external warehouse management system (WMS) or transport management system (TMS) via a secure API or a message-oriented middleware. These requests can include multiple lists of items 806 to be packed onto multiple pallets to fulfill orders for one or more of the first outbound transport vehicle 840A docked at a first loading door 818 and the second outbound transport vehicle 840B scheduled to dock at a second loading door 818 within a predetermined period of time. In some examples, the computer system 810 and/or 820 can analyze the expected arrival times and shipping priorities of incoming vehicles to categorize orders into immediate, near-term, and future staging buckets. This ensures that the orchestration plan accounts for both immediate loading requirements and near-term staging needs to prevent bottlenecks at the loading doors 818, such as instances where a vehicle arrives but its corresponding pallets are buried behind lower-priority inventory.

At 1315, an initial facility state can be identified. For example, the computer system 810 and/or 820 can identify the baseline coordinates of source pallets, the availability of facility workers 808, and the real-time status of the transport vehicles 840A, 840B at the loading doors 818. This identification can further include capturing the current battery levels and mechanical availability of automated vehicles 804A, the current congestion levels in specific aisles 808A, 808B, and the ongoing progress of replenishment tasks already in execution. In some examples, the computer system 810 and/or 820 can use these variables as weighted constraints in the arrangement model to ensure tasks are assigned to equipment with sufficient power reserves or directed to less congested routes. By generating this comprehensive facility snapshot, the computer system 810 and/or 820 can create a global context that allows the arrangement model to solve for total facility efficiency. This approach avoids the technical pitfall of localized optimization, where individual task efficiency is improved at the expense of cumulative system throughput and resource availability.

At 1320, candidate pick items in the facility can be identified to fulfill the pick order requests. For example, the computer system 810 and/or 820 can scan the inventory database to select specific candidate pick items, such as item 806F in a ground-level pick zone 872 or items 806D and 806E in elevated storage locations 870. The system may identify multiple potential source pallets for a single SKU based on FIFO (First-In, First-Out) logic, owner codes, or batch number requirements. Identifying these items as “candidates” allows the system 810 and/or 820 to evaluate multiple sourcing combinations to determine which specific pallets minimize travel distance or facilitate the most efficient layer-based picking operations. Furthermore, the system can identify items that are already scheduled for replenishment, allowing the orchestration engine to plan pick tasks that coincide with the arrival of a source pallet in a high-access zone.

At 1325, locations of the candidate pick items in the facility can be identified. For example, the computer system 810 and/or 820 can determine the specific aisle, rack, shelf, and storage level coordinates for each candidate item. This identification involves mapping the three-dimensional coordinates of each item relative to the loading doors 818. In some examples, the system identifies whether an item is located in an “active” pick zone 872 for direct manual access or in a “reserve” elevated storage location 870 that requires mechanical reach. By identifying these coordinates, the computer system 810 and/or 820 can calculate the temporal and mechanical cost of retrieving each item, accounting for the horizontal travel time on the warehouse floor and the vertical lift time required for high-reach equipment. This calculation can also incorporate historical data on equipment performance to estimate more accurate task durations.

At 1330, cases of the candidate pick items to be picked can be identified. For example, the computer system 810 and/or 820 can identify individual containers, boxes, or cartons to be picked from source pallets to fulfill the specific quantities requested. In some examples, the system performs a volumetric analysis to determine the “break point” between picking individual cases and picking full layers. If an order request for item 806F constitutes a significant portion of a full layer, the system 810 and/or 820 may identify a full layer pick as the primary task, followed by a case-level adjustment to return the excess inventory to storage. Identifying these cases at a granular level allows the arrangement model to plan the precise vertical and horizontal placement of each unit on the destination pallet 816, ensuring that the volume of the destination pallet is fully optimized to reduce the total number of pallets required for an order.

At 1335, an order for picking the cases can be determined based on structural information. For example, the computer system 810 and/or 820 can evaluate metadata associated with each case, including weight, dimensions, crushability ratings, fragility, and surface friction coefficients. Based on these parameters, the system can determine orientation constraints to prevent sliding during transit or to ensure that barcodes remain accessible for scanning. Based on this structural information, the system 810 and/or 820 determines a pick order that ensures the integrity of the built pallet. Heavier items with high structural density are sequenced to be packed earlier to form a stable base layer, while lighter or more fragile items are sequenced to be packed later, directly or indirectly on top of the heavier base layers, such as by placing a fragile item on top of a mid-weight item that is itself supported by the high-density base. This determination may also account for the center of gravity of the completed pallet to ensure stability during high-speed transport or turning maneuvers performed by the facility vehicles 804A, thereby reducing the risk of product damage or vehicle accidents.

At 1340, build instructions for one or more pallets of the multiple pallets can be determined. For example, the computer system 810 and/or 820 can generate instructions based on item data corresponding to each identified case, such as the specific interlocking pattern required to prevent shifting during transit. These patterns can include “brick” or “chimney” stacking arrangements that enhance the sheer strength of the palletized load. In some examples, these instructions include the precise X-Y-Z coordinates for the placement of each case on the destination pallet. This step focuses on the geometry of the individual pallet build, ensuring that the physical constraints of the destination pallet (e.g., height limits, weight limits) are strictly adhered to while maximizing the density of the load.

At 1345, build instructions can be determined through a centralized orchestration logic. For example, the computer system 810 and/or 820 can execute an arrangement model, such as a mixed-integer program (MIP), for a predetermined maximum amount of time to interdependently coordinate the build instructions for the entire facility. This global optimization solves for the minimum total travel time and energy expenditure across all active tasks. By solving for these instructions interdependently, the system 810 and/or 820 can prevent resource contention, such as multiple workers 808 attempting to access the same narrow aisle 808A simultaneously. The system can prioritize the return of the best-found solution upon the expiration of the processing timer. This ensures that facility vehicles 804A and workers 808 do not experience mechanical idleness while waiting for a mathematically perfect solution that may only offer marginal gains over the current best-found result.

At 1350, build instructions can be transmitted. For example, the computer system 810 and/or 820 can transmit the instructions as control packets over a high-speed network, such as Wi-Fi, 5G, or private LTE, to mobile computing devices. These instructions cause the receiving device to display route guidance, turn-by-turn navigation, or execution commands that route a facility worker 808 or an automated layer picker (e.g., vehicle 804A) to pick the cases according to the coordinated sequence. The transmission can include metadata such as estimated arrival times at pick locations to synchronize the movements of multiple independent actors on the warehouse floor, effectively reducing the frequency of worker idle time and equipment bottlenecks.

At 1355, a determination can be made as to whether an updated facility state has been identified. For example, the computer system 810 and/or 820 can monitor for real-time environmental updates, such as the early arrival of a transport vehicle 840B, a reporting of an execution failure where a damaged item 806E was discovered, or a change in the priority of the pick order requests 832. If no update is detected, the process proceeds to block 1360.

At 1360, the build instructions can be transmitted. For example, if the facility state remains consistent with the initial identification, the system continues transmitting the existing instruction queue to the execution layer. This ensures that facility workers 808 and vehicles 804A always have a steady stream of work, maintaining continuous operation without the need for redundant processing cycles or manual task requests.

If an updated facility state is detected at 1355, updated build instructions can be determined at 1365. For example, the computer system 810 and/or 820 can re-evaluate the unreleased build instructions against the new variables. The system identifies updated item data for the candidate cases and determines a modified sequence that yields a higher efficiency score. Crucially, this determination excludes tasks that are associated with a locked status flag in the indexed instruction buffer, representing work already in progress. This ensures that the re-optimization loop treats these active assignments as fixed physical constraints, preventing plan instability and protecting the effort already invested by the facility staff. This re-optimization may involve identifying an alternative storage coordinate for a depleted SKU or re-sequencing the remaining tasks to accommodate a new urgent order. The updated instructions indicate the placement of each identified case directly or indirectly on top of the base layer, maintaining the structural stability requirements established at step 1335.

At 1370, updated build instructions can be transmitted. For example, the computer system 810 and/or 820 can transmit the updated instructions to the mobile computing device. By transmitting only the modifications required to transition from the previous plan to the new plan, such as delta updates, the system reduces the volume of network traffic. This targeted transmission limits the frequency of context-switching interrupts on the CPU of the mobile computing device, which preserves the availability of system resources for real-time sensor processing and UI responsiveness. This technical optimization reduces the context-switching overhead on the mobile device, which improves battery life and ensures that the communication channel remains available for critical safety alerts or status updates. For a facility worker 808, these updates might appear as a subtle redirection in their pick path that reflects the most recent warehouse priorities without requiring them to restart their entire route.

By following this iterative orchestration process, the computer system 810 and/or 820 can improve the operational throughput of the facility 802 and optimize space utilization. This allows the facility 802 to do more with less physical square footage by increasing the density of pick and storage operations. In some examples, this improved efficiency allows the facility 802 to operate within a smaller physical footprint compared to conventional facilities, which reduces the energy required to heat, cool, and illuminate the facility 802 by decreasing the total cubic volume of the climate-controlled envelope and reducing the duty cycles of lighting systems in inactive zones. Furthermore, increasing the operational density through dynamic orchestration reduces the total distances traveled by vehicles 804A, thereby reducing the cumulative mechanical wear on the equipment, lowering electrical power consumption of the motors, and improving the overall energy efficiency and environmental impact of the logistics facility.

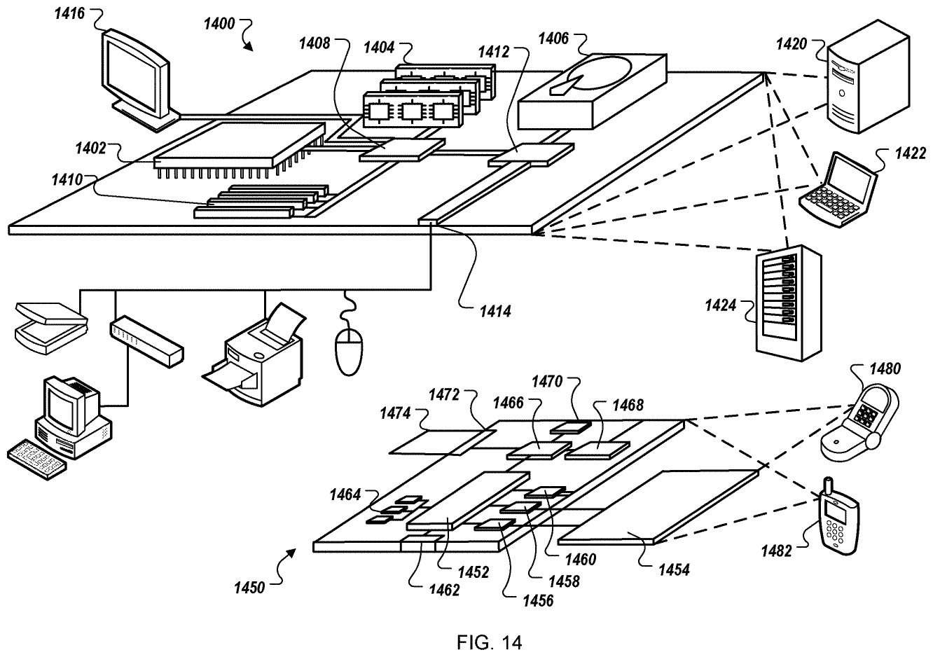

FIG. 14 is a schematic diagram that shows an example of a computing device 1400 and a mobile computing device that can be used to perform the techniques described herein. The computing device 1400 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 1400 includes a processor 1402, a memory 1404, a storage device 1406, a high-speed interface 1408 connecting to the memory 1404 and multiple high-speed expansion ports 1410, and a low-speed interface 1412 connecting to a low-speed expansion port 1414 and the storage device 1406. Each of the processor 1402, the memory 1404, the storage device 1406, the high-speed interface 1408, the high-speed expansion ports 1410, and the low-speed interface 1412, are interconnected using various busses, and can be mounted on a common motherboard or in other manners as appropriate. The processor 1402 can process instructions for execution within the computing device 1400, including instructions stored in the memory 1404 or on the storage device 1406 to display graphical information for a GUI on an external input/output device, such as a display 1416 coupled to the high-speed interface 1408. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 1404 stores information within the computing device 1400. In some implementations, the memory 1404 is a volatile memory unit or units. In some implementations, the memory 1404 is a non-volatile memory unit or units. The memory 1404 can also be another form of computer-readable medium, such as a magnetic or optical disk.

The storage device 1406 is capable of providing mass storage for the computing device 1400. In some implementations, the storage device 1406 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer-or machine-readable medium, such as the memory 1404, the storage device 1406, or memory on the processor 1402.

The high-speed interface 1408 manages bandwidth-intensive operations for the computing device 1400, while the low-speed interface 1412 manages lower bandwidth-intensive operations. Such allocation of functions is exemplary only. In some implementations, the high-speed interface 1408 is coupled to the memory 1404, the display 1416 (e.g., through a graphics processor or accelerator), and to the high-speed expansion ports 1410, which can accept various expansion cards (not shown). In the implementation, the low-speed interface 1412 is coupled to the storage device 1406 and the low-speed expansion port 1414. The low-speed expansion port 1414, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 1400 can be implemented in a number of different forms, as shown in the figure. For example, it can be implemented as a standard server 1420, or multiple times in a group of such servers. In addition, it can be implemented in a personal computer such as a laptop computer 1422. It can also be implemented as part of a rack server system 1424. Alternatively, components from the computing device 1400 can be combined with other components in a mobile device (not shown), such as a mobile computing device 1450. Each of such devices can contain one or more of the computing device 1400 and the mobile computing device 1450, and an entire system can be made up of multiple computing devices communicating with each other.

The mobile computing device 1450 includes a processor 1452, a memory 1464, an input/output device such as a display 1454, a communication interface 1466, and a transceiver 1468, among other components. The mobile computing device 1450 can also be provided with a storage device, such as a micro-drive or other device, to provide additional storage. Each of the processor 1452, the memory 1464, the display 1454, the communication interface 1466, and the transceiver 1468, are interconnected using various buses, and several of the components can be mounted on a common motherboard or in other manners as appropriate.

The processor 1452 can execute instructions within the mobile computing device 1450, including instructions stored in the memory 1464. The processor 1452 can be implemented as a chipset of chips that include separate and multiple analog and digital processors. The processor 1452 can provide, for example, for coordination of the other components of the mobile computing device 1450, such as control of user interfaces, applications run by the mobile computing device 1450, and wireless communication by the mobile computing device 1450.

The processor 1452 can communicate with a user through a control interface 1458 and a display interface 1456 coupled to the display 1454. The display 1454 can be, for example, a TFT (Thin-Film-Transistor Liquid Crystal Display) display or an OLED (Organic Light Emitting Diode) display, or other appropriate display technology. The display interface 1456 can include appropriate circuitry for driving the display 1454 to present graphical and other information to a user. The control interface 1458 can receive commands from a user and convert them for submission to the processor 1452. In addition, an external interface 1462 can provide communication with the processor 1452, so as to enable near area communication of the mobile computing device 1450 with other devices. The external interface 1462 can provide, for example, for wired communication in some implementations, or for wireless communication in other implementations, and multiple interfaces can also be used.

The memory 1464 stores information within the mobile computing device 1450. The memory 1464 can be implemented as one or more of a computer-readable medium or media, a volatile memory unit or units, or a non-volatile memory unit or units. An expansion memory 1474 can also be provided and connected to the mobile computing device 1450 through an expansion interface 1472, which can include, for example, a SIMM (Single In Line Memory Module) card interface. The expansion memory 1474 can provide extra storage space for the mobile computing device 1450, or can also store applications or other information for the mobile computing device 1450. Specifically, the expansion memory 1474 can include instructions to carry out or supplement the processes described above, and can include secure information also. Thus, for example, the expansion memory 1474 can be provide as a security module for the mobile computing device 1450, and can be programmed with instructions that permit secure use of the mobile computing device 1450. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer-or machine-readable medium, such as the memory 1464, the expansion memory 1474, or memory on the processor 1452. In some implementations, the computer program product can be received in a propagated signal, for example, over the transceiver 1468 or the external interface 1462.

The mobile computing device 1450 can communicate wirelessly through the communication interface 1466, which can include digital signal processing circuitry where necessary. The communication interface 1466 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 1468 using a radio-frequency. In addition, short-range communication can occur, such as using a Bluetooth, WiFi, or other such transceiver (not shown). In addition, a GPS (Global Positioning System) receiver module 1470 can provide additional navigation-and location-related wireless data to the mobile computing device 1450, which can be used as appropriate by applications running on the mobile computing device 1450.

The mobile computing device 1450 can also communicate audibly using an audio codec 1460, which can receive spoken information from a user and convert it to usable digital information. The audio codec 1460 can likewise generate audible sound for a user, such as through a speaker, e.g., in a handset of the mobile computing device 1450. Such sound can include sound from voice telephone calls, can include recorded sound (e.g., voice messages, music files, etc.) and can also include sound generated by applications operating on the mobile computing device 1450.

The mobile computing device 1450 can be implemented in a number of different forms, as shown in the figure. For example, it can be implemented as a cellular telephone 1480. It can also be implemented as part of a smart-phone 1482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications, or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable sub-combination. Moreover, although features may be described herein as acting in certain combinations and/or initially claimed as such, one or more features from a claimed combination can in some cases be excised from the combination, and the claimed combination may be directed to a sub-combination or variation of a sub-combination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method for dynamically optimizing pallet build sequences across a facility, the method comprising:
receiving, by a computing system, a plurality of pick order requests comprising a plurality of lists of items to be packed onto a plurality of pallets;
identifying, by the computing system, candidate pick items in the facility that can be used to fulfill the plurality of pick order requests;
identifying, by the computing system, locations of the candidate pick items in the facility;
identifying, by the computing system, one or more full layers of at least one of the candidate pick items, wherein at least one of the full layers comprises a base layer for one or more of the plurality of pallets;
identifying, by the computing system, cases of the candidate pick items to be picked to fulfill the plurality of pick order requests;
determining, by the computing system and based on structural information for the identified cases of the candidate pick items, an order for picking the cases of the candidate pick items to be packed on top of the one or more full layers that comprise the base layer for one or more pallets of the plurality of pallets;
determining, by the computing system, build instructions for the one or more pallets of the plurality of pallets based on item data corresponding to each of the identified cases; and
transmitting, by the computing system to a computing device, the build instructions that, when executed, cause the computing device to route a facility worker or an automated layer picker to pick the cases according to the build instructions.

2. The method of claim 1, wherein the plurality of pick order requests is based on a plurality of outbound transport vehicles.

3. The method of claim 2, wherein the plurality of outbound transport vehicles comprises one or more outbound transport vehicles docked at one or more loading doors, and one or more other outbound transport vehicles scheduled to dock at one or more loading doors within a predetermined period of time.

4. The method of claim 1, further comprising:
identifying, by the computing system, a first facility state, wherein the build instructions are further based on the first facility state;
identifying, by the computing system, an updated facility state;
determining, by the computing system, updated build instructions for the one or more pallets of the plurality of pallets based on updated item data corresponding to each of the identified cases, wherein the updated build instructions indicate placement of each of the identified cases directly or indirectly on top of the base layer; and
transmitting, by the computing system to a computing device, the updated build instructions that, when executed, cause the computing device to route the facility worker or the automated layer picker to pick the cases according to the updated build instructions.

5. The method of claim 4, wherein the updated facility state comprises a reported pallet build execution failure, and wherein the computing system automatically resolves the reported pallet build execution failure by canceling at least a portion of the build instructions and creating the updated build instructions without requiring manual inventory control intervention.

6. The method of claim 1, wherein the locations of the candidate pick items distinguish between ground-level pick zone locations and elevated storage locations in the facility.

7. The method of claim 6, further comprising:
executing, by the computing system, an arrangement model configured to generate the build instructions, wherein generating the build instructions comprises interdependently determining:
a sequence of replenishment tasks for moving source pallets from the elevated storage locations into the ground-level pick zone locations; and
a sequence of outbound pick tasks to fulfill the plurality of pick order requests, the outbound pick tasks comprising partial picks from the ground-level pick zone locations and cherry picks from the elevated storage locations.

8. The method of claim 7, wherein executing the arrangement model comprises processing a mixed integer program for a predetermined maximum amount of time, and returning a best-found solution for the build instructions upon expiration of the predetermined maximum amount of time.

9. The method of claim 7, further comprising:
storing, by the computing system, the build instructions in an unreleased state;
re-evaluating, by the computing system at a configured time interval, the build instructions in the unreleased state against an updated facility state; and
in response to determining that a modified sequence of outbound pick tasks and replenishment tasks yields a higher efficiency score for the updated facility state, canceling at least one of the build instructions in the unreleased state and creating a new build instruction to fulfill a corresponding one of the build instructions.

10. The method of claim 9, further comprising:
assigning a first portion of the build instructions of the build instructions to the facility worker or the automated layer picker for execution;
transitioning the first portion of the build instructions from the unreleased state to a locked state in response to the assigning; and
excluding the first portion of the build instructions in the locked state from being canceled during the re-evaluating by the computing system.

11. The method of claim 9, wherein determining the modified sequence of outbound pick tasks further comprises:
identifying one or more other full layers of at least one of the candidate pick items to comprise the base layer for one or more of the plurality of pallets; and
iteratively determining another order for picking the cases of the candidate pick items to be packed on top of the one or more full layers that comprise the base layer.

12. The method of claim 1, wherein the structural information comprises a maximum weight load that each case can support without being crushed.

13. The method of claim 12, wherein the maximum weight load for each of the identified cases is determined in a process comprising:
determining a load on a layer of a source pallet having at least one of the identified cases, wherein the load is a weight for a layer multiplied by one less than a number of layers on the source pallet, and determining the maximum weight load based on applying a margin threshold to the load.

14. A facility comprising:
a plurality of storage locations in the facility configured to store a plurality of items;
at least one facility vehicle configured to travel to the plurality of storage locations to pick items used for fulfilling customer orders; and
a computer system configured to (i) determine pallet build sequences in the facility using the plurality of items stored in the plurality of storage locations and (ii) control the at least one facility vehicle to automatically perform the pallet build sequences, wherein the computer system performs operations comprising:
receiving a plurality of pick order requests comprising a plurality of lists of items to be packed onto a plurality of pallets;
identifying candidate pick items in the facility that can be used to fulfill the plurality of pick order requests;
identifying locations of the candidate pick items in the facility;
identifying one or more full layers of at least one of the candidate pick items, wherein at least one of the full layers comprises one or more base layers for one or more of the plurality of pallets;
identifying cases of the candidate pick items to be picked to fulfill the plurality of pick order requests;
determining, based on structural information for the identified cases of the candidate pick items, an order for picking the cases of the candidate pick items to be packed on top of the one or more full layers that comprise one or more base layers for one or more pallets of the plurality of pallets;
determining build instructions for the one or more pallets of the plurality of pallets based on item data corresponding to each of the identified cases; and
transmitting to a computing device the build instructions that, when executed, cause the computing device to route a facility worker or the at least one facility vehicle to pick the cases according to the build instructions.

15. The facility of claim 14, wherein the structural information comprises a maximum weight load that each case can support without being crushed, wherein the maximum weight load for each of the identified cases is determined in a process comprising:
determining a load on a layer of a source pallet having at least one of the identified cases, wherein the load is a weight for a layer multiplied by one less than a number of layers on the source pallet, and determining the maximum weight load based on applying a margin threshold to the load.

16. The facility of claim 14, wherein determining the order for picking the identified cases comprises:
selecting a next nearest case of the candidate pick items to a storage location of at least one of the full layers;
determining whether a storage location of the next nearest case is within a threshold distance from the storage location of the at least one of the full layers; and
selecting the next nearest case to be picked for packing on top of the one or more base layers based on determining that the storage location of the next nearest case is within the threshold distance.

17. The facility of claim 16, wherein determining the order for picking the identified cases comprises:
selecting a case of the candidate pick items;
determining whether the selected case can support a minimum threshold weight positioned on top of the selected case without being crushed; and
identifying the selected case to be picked for packing on top of the one or more base layers based on a determination that the selected case can support the minimum threshold weight without being crushed.

18. The facility of claim 14, wherein the plurality of pick order requests is based on a plurality of outbound transport vehicles.

19. The facility of claim 18, wherein the plurality of outbound transport vehicles comprises one or more outbound transport vehicles docked at one or more loading doors, and one or more other outbound transport vehicles scheduled to dock at one or more loading doors within a predetermined period of time.

20. The facility of claim 14, further comprising:
identifying, by the computing system, a first facility state, wherein the build instructions are further based on the first facility state;
identifying, by the computing system, an updated facility state;
determining, by the computing system, updated build instructions for the one or more pallets of the plurality of pallets based on updated item data corresponding to each of the identified cases, wherein the updated build instructions indicate placement of each of the identified cases directly or indirectly on top of the one or more base layers; and
transmitting, by the computing system to a computing device, the updated build instructions that, when executed, cause the computing device to route the facility worker or the at least one facility vehicle to pick the cases according to the updated build instructions.

21. A method for dynamically optimizing pallet build sequences across a facility, the method comprising:
receiving, by a computing system, a plurality of pick order requests comprising a plurality of lists of items to be packed onto a plurality of pallets for one or more of a first outbound transport vehicle docked at a first loading door of the facility and a second outbound transport vehicle scheduled to dock at a second loading door of the facility within a predetermined period of time;
identifying, by the computing system, a first facility state;
identifying, by the computing system, candidate pick items in the facility that can be used to fulfill the plurality of pick order requests based on the first facility state;
identifying, by the computing system, locations of the candidate pick items in the facility based on the first facility state;
identifying, by the computing system, cases of the candidate pick items to be picked to fulfill the plurality of pick order requests;
determining, by the computing system and based on structural information for the identified cases of the candidate pick items, an order for picking the cases of the candidate pick items to be packed on top of one or more full layers that comprise a base layer for one or more pallets of the plurality of pallets;
determining, by the computing system, build instructions for the one or more pallets of the plurality of pallets based on item data corresponding to each of the identified cases;
transmitting, by the computing system to a computing device, the build instructions that, when executed, cause the computing device to route a facility worker or an automated layer picker to pick the cases according to the build instructions;
identifying, by the computing system, an updated facility state;
determining, by the computing system, updated build instructions for the one or more pallets of the plurality of pallets based on updated item data corresponding to each of the identified cases, wherein the updated build instructions indicate placement of each of the identified cases directly or indirectly on top of the base layer; and
transmitting, by the computing system to a computing device, the updated build instructions that, when executed, cause the computing device to route the facility worker or the automated layer picker to pick the cases according to the updated build instructions.
